(19) United States
(12) Patent Application Publication
(10) Pub. No.: US 2009/0018031 A1
(43) Pub. Date: Jan. 15, 2009

(54) Transcriptional regulatory elements of biological pathways tools, and methods

(75) Inventors: Nathan Trinklein, Redwood City, CA (US); Shelley Force Aldred, Hayward, CA (US)

Correspondence Address: WILSON SONSINI GOODRICH & ROSATI, 650 PAGE MILL ROAD, PALO ALTO, CA, 94304-1050, US

(73) Assignee: SwitchGear Genomics, Menlo Park, CA (US)

(21) Appl. No.: 11/999,792

(22) Filed: Dec. 6, 2007

Related U.S. Application Data
(60) Provisional application No. 60/873,871, filed on Dec. 7, 2006.
(60) Provisional application No. 60/873,853, filed on Dec. 7, 2006.
(60) Provisional application No. 60/873,737, filed on Dec. 7, 2006.
(60) Provisional application No. 60/873,739, filed on Dec. 7, 2006.
(60) Provisional application No. 60/873,882, filed on Dec. 7, 2006.
(60) Provisional application No. 60/873,883, filed on Dec. 7, 2006.
(60) Provisional application No. 60/873,738, filed on Dec. 7, 2006.
(60) Provisional application No. 60/958,616, filed on Jul. 6, 2007.

(51) Int. Cl. C40B 30/06; C40B 40/06; C40B 40/02; C40B 60/00

(52) U.S. Cl. 506/10; 506/16; 506/14; 506/33

(57) ABSTRACT

The present invention provides compositions, kits, assemblies, libraries, arrays, and high throughput methods for large scale structural and functional characterization of gene expression regulatory elements in a genome of an organism, especially in a human genome, that are part of a common pathway. In one aspect of the invention, an array of expression constructs is provided, each of the expression constructs comprising: a nucleic acid segment operably linked with a reporter sequence in an expression vector such that expression of the reporter sequence is under the transcriptional control of the nucleic acid segment. The present invention can have a wide variety of applications such as in personalized medicine, pharmacogenomics, and correlation of polymorphisms with phenotypic traits.

### CROSS-REFERENCE

This application claims the benefit of U.S. Provisional Application No. 60/873,871, filed Dec. 7, 2006; U.S. Provisional Application No. 60/873,853, filed Dec. 7, 2006; U.S. Provisional Application No. 60/873,737, filed Dec. 7, 2006; U.S. Provisional Application No. 60/873,739, filed Dec. 7, 2006; U.S. Provisional Application No. 60/873,882, filed Dec. 7, 2006; U.S. Provisional Application No. 60/873,883, filed Dec. 7, 2006; U.S. Provisional Application No. 60/873,738, filed Dec. 7, 2006; and U.S. Provisional Application No. 60/958,616, filed Jul. 6, 2007, which are incorporated herein by reference in their entirety.

### SEQUENCE LISTING

A CD containing a formal sequence listing was filed in this application and the contents of the CD are expressly incorporated herein in their entirety by reference.

### BACKGROUND OF THE INVENTION

The regulation of human gene expression is a critical, highly coordinated, and complex process. Gene regulation plays a crucial role in virtually every biological process from coordinating cell division to responding to extracellular stimuli and directing transcription during development (Ahituv et al. 2004; Blais and Dynlacht 2004; Pirkkala et al. 2001). While knowledge of regulation at the level of individual genes is progressing, global characterization of gene regulation currently represents one of the major challenges and fundamental goals for biomedical research. An initial step in achieving this goal is the comprehensive identification of transcriptional regulatory elements in the human genome. Towards this end, the ENCODE (Encyclopedia of DNA Elements) project began in 2004 as a collective effort of many labs to identify the functional elements in 1% of the human genome (The ENCODE Project Consortium 2004).

Promoters are the best-characterized transcriptional regulatory sequences in complex genomes because of their predictable location immediately upstream of transcription start sites (TSS). They are often described as having two separate segments: core and extended promoter regions. The core promoter is generally within 50 bp of the TSS, where the pre-initiation complex forms and the general transcription machinery assembles. The extended promoter can contain specific regulatory sequences that control spatial and temporal expression of the downstream gene (reviewed in (Butler and Kadonaga 2002)).

Several technologies currently exist to study the functional regions of the human genome. Expression microarrays enable researchers to measure the steady state level of all the genes in the genome under different conditions. Another technique that combines chromatin immunoprecipitation and genomic microarrays (ChIP-chip) can determine the binding sites of a transcription factor across the genome. Sequencing the genomes of many different individuals and even different species can also show which sequences in the genome are under selective constraint. Additionally, assays of epigenetic modifications such as DNA-methylation status add more information to regulatory element studies. All of these experimental approaches produce valuable observations, but they do not directly measure the function of DNA regulatory elements especially in the context of specific biological pathways. The present invention provides innovative solutions that directly measure the function of regulatory elements in the context of gene regulation of specific biological pathways. The present invention enables the characterization of regulatory elements in specific biological pathways and uses of the information generated in the functional studies for research, diagnosis, prevention and treatment of diseases or conditions.

### SUMMARY OF THE INVENTION

The invention relates to methods, compositions and devices, e.g., for functional and structural characterization of genes. In one aspect the invention, a library is provided. In some embodiments the library comprises of a plurality of different expression constructs, each member of the library comprising a different nucleic acid segment from a genome, where the segment comprises transcription regulatory sequences operably linked with a heterologous reporter sequence in an expression vector such that expression of the reporter sequence is under transcriptional control of the transcription regulatory sequences, and where a plurality comprising at least 20% of the transcription regulatory sequences of said expression constructs in said library are part of a common pathway.

In some embodiments the transcription regulatory sequences that are part of a common pathway in the library control the expression of genes involved in the same biological process. In some embodiments, the transcription regulatory sequences that are part of a common pathway in the library are all bound by the same transcription factor protein, complex of transcription factor proteins, other nucleic acid binding proteins, or other small molecule. In some embodiments, the transcription regulatory sequences that are part of a common pathway in the library control the expression of genes whose transcript levels or proteins levels change upon treatment or exposure to the same stimulus. In some embodiments, the transcription regulatory sequences that are part of a common pathway in the library contain the same DNA sequence motif or collection of DNA sequence motifs wherein a sequence motif is string of 2 or more nucleotides. In some embodiments, the transcription regulatory sequences that are part of a common pathway in the library control the expression of genes whose sequences, transcripts or proteins are connected via metabolic transformations and/or physical protein-protein, protein-DNA and protein-compound interactions.

In some embodiments, the common pathway is selected from the group consisting of oncology, membrane, vascular, neuronal, signaling and nuclear receptor pathway. In some embodiments, the common pathway is an oncology pathway. In some embodiments, the oncology pathway is selected from the group consisting of hypoxia pathway, DNA-damage pathway, apoptosis pathway, cell cycle pathway, and p53 pathway. In some embodiments, a plurality of transcription regulatory sequences in an oncology pathway are differently selected from the group consisting of hypoxia pathway, DNA-damage pathway, apoptosis pathway, cell cycle pathway, and p53 pathway. In some embodiments, the regulatory elements in an oncology pathway are selected from the group consisting of SEQ ID NO: 1-3836.

In some embodiments, the common pathway is a membrane pathway. In some embodiments, the membrane pathway is selected from the group consisting of transport protein pathways, G-protein coupled receptor pathways, ion channel pathways, and cell adhesion protein pathways. In some embodiments, a plurality of transcription regulatory sequences in a membrane pathway are differently selected from the group consisting of transport protein pathways, G-protein coupled receptor pathways, ion channel pathways, and cell adhesion protein pathways. In some embodiments, the regulatory elements in a membrane pathway are selected from the group consisting of SEQ ID NO: 3837-12716.

In some embodiments the common pathway is a nuclear receptor pathway. In some embodiments, the nuclear receptor pathway is selected from the group consisting of glucocorticoid receptor pathway, peroxisome proliferator-activated receptor pathway, estrogen receptor pathway, androgen receptor pathway, cytochrome P450 pathway, and transporter pathways. In some embodiments, a plurality of transcription regulatory sequences in a nuclear pathway are differently selected from the group consisting of glucocorticoid receptor pathway, peroxisome proliferator-activated receptor pathway, estrogen receptor pathway, androgen receptor pathway, cytochrome P450 pathway, and transporter pathways. In some embodiments, the regulatory elements in a nuclear receptor pathway are selected from the group consisting of SEQ ID NO: 12717-13994.

In some embodiments, the library comprises at least ten, at least 50, at least 100, at least 200, or at least 1000 expression constructs. In some embodiments, the segments in the library have an average length of at least 200 nucleotides. In some embodiments, the average length of the nucleic acid segments in the library is between 200 nucleotides and 3000 nucleotides. In some embodiments, each nucleic acid segment in the library comprises at least 200 nucleotides upstream of a transcriptional start site.

In some embodiments, the reporter sequences encode the same reporter molecule. In some embodiments, the reporter sequence encodes a light-emitting reporter molecule, a fluorescent reporter molecule or a colorimetric molecule. In some embodiments, each reporter sequence comprises a pre-determined, unique nucleotide barcode and/or a reporter that reports a visible signal.

In some embodiments, the library comprises a different nucleic acid segment from a genome, where the genome is a mammalian genome. In some embodiments, the genome is a human genome. In some embodiments, the genome is a mouse genome.

In some embodiments, the library comprises at least 10 different expression constructs, where about 50% of the transcription regulatory sequences of the expression constructs in the library are part of a common pathway.

In some embodiments, the invention provides a library of isolated nucleic acid molecules, each member of the library comprising a different, pre-determined nucleic acid segment from a genome, where the segment comprises transcription regulatory sequences, and where a plurality comprising at least 20% of the transcription regulatory sequences in the library are part of a common pathway. In some embodiments, the library comprises at least 10 different pre-determined nucleic acid segments from a genome, where about 50% of the transcription regulatory sequences of the library are part of a common pathway.

In some embodiments, the invention provides a library of cells, where each cell in the library of cells comprises a different member of a library of expression constructs, where each member of the library of expression constructs comprises a different nucleic acid segment from a genome, where the segment comprises transcription regulatory sequences, operably linked with a heterologous reporter sequence in an expression vector such that expression of the reporter sequence is under transcriptional control of the transcription regulatory sequences, and where a plurality comprising at least 20% of the transcription regulatory sequences of the expression constructs in said library are part of a common pathway. In some embodiments, the cells are human cells. In some embodiments, the cells are non-human cells. In some embodiments, the library of cells comprises at least at least 10 different expression constructs where about 50% of the transcription regulatory sequences of the expression constructs in the library are part of a common pathway.

In one aspect of the invention, a device is provided. In some embodiments, the device comprises a plurality of receptacles, each receptacle containing a different member of a library of expression constructs, each expression construct comprising a different, nucleic acid segment from a genome, where the segment comprises transcription regulatory sequences, operably linked with a heterologous reporter sequence in an expression vector such that expression of the reporter sequence is under transcriptional control of the transcription regulatory sequences, where a plurality comprising at least 20% of the transcription regulatory sequences of said expression constructs in said library are part of a common pathway and where each member has a known location among the receptacles.

In some embodiments the library in the device has a diversity of at least 10 different nucleic acid segments. In some embodiments, each nucleic acid segment in the device is naturally linked in the genome with a sequence expressed as a cDNA. In some embodiment, the average length of the nucleic acid segments in the library is at least 200 nucleotides. In some embodiments, the constructs are in the form of a dried nucleic acid or are in solution. In some embodiments, the constructs are in a stabilized transfection matrix.

In some embodiments, the device comprises a microtiter plate. In some embodiment, the microtiter plate is a 96-well plate, a 384-well plate or a 1536 well plate.

In some embodiments, the device comprises at least at least 10 different expression constructs where about 50% of the transcription regulatory sequences of the expression constructs in the library are part of a common pathway.

In some embodiments, the invention provides a device comprising a solid substrate comprising a surface and nucleic acid molecules immobilized to the surface, each at a different known location, where each molecule comprises a nucleotide sequence of at least 10 nucleotides from a genomic segment comprising transcription regulatory sequences and where a plurality comprising at least 20% of the transcription regulatory sequences in the device are part of a common pathway.

In some embodiments the device comprises transcription regulatory sequences from at least 10 different genomic segments. In some embodiments, the device comprises at least 10 different transcription regulatory sequences from genomic segments where about 50% of the transcription regulatory sequences in the device are part of a common pathway. In some embodiments, each nucleic acid segment in the device is naturally linked in the genome with a sequence expressed as a cDNA. In some embodiments, the nucleic acid segments in the device are no more than 60 nucleotides long. In some embodiments, each genomic segment in the device is represented by a set comprising a plurality of molecules, each molecule in the set comprising a different nucleotide sequence from the genomic segment.

In one aspect of the invention, methods are provided. In some embodiments, the invention provides for a method that comprises: (a) providing a device comprising a plurality of receptacles, each receptacle containing a different member of a library of cells, where each cell in the library of cells comprises a different member of the library of expression constructs, each expression construct comprising a different nucleic acid segment from a genome, where the segment comprises transcription regulatory sequences, operably linked with a heterologous reporter sequence in an expression vector such that expression of the reporter sequence is under transcriptional control of the transcription regulatory sequences; where a plurality comprising at least 20% of the transcription regulatory sequences in the device are part of a common pathway and where each member of the library of cells has a known location among the receptacles; (b) culturing the cells; and (c) measuring the level of expression of the reporter sequence in each receptacle. In some embodiments of the methods of the invention, the library has a diversity of at least 10 different nucleic acid segments. In some embodiments, each nucleic acid segment is naturally linked in the genome with a sequence expressed as a RNA molecule. In some embodiments, the average length of the nucleic acid segments in the library is at least 200 nucleotides.

In some embodiments, the method in step (a) above further comprises: (i) providing a device comprising at least one plate comprising a plurality of receptacles, each receptacle containing a different member of the library of expression constructs, where each member of the library of expression constructs has a known location among the receptacles; (ii) delivering cells to each of the receptacles; and (iii) transfecting the cells with the expression constructs.

In some embodiments, the method further comprises: (d) perturbing the cells in each receptacle; (e) measuring the level of expression of the reporter sequence in each receptacle; and (f) determining whether the level of expression in any receptacle changed after perturbing the cells. In some embodiments, perturbing comprises contacting the cells in each receptacle with a test compound, exposing the cells to different environmental conditions, or genetically modifying the cells either permanently or transiently such as by inducing mutation, overexpressing a transcript for example by transfecting with a cDNA or decreasing expression of a transcript by siRNA. In some embodiments, perturbing comprises contacting the cells in each receptacle with a test compound. In some embodiments, the method further comprises identifying a compound that alters transcription of one or more polynucleotides.

In some embodiments, the cells in the library of cells comprise cells associated with a condition. In some embodiments, each cell in the library of cells comprises a DNA polymorphism, DNA mutation or DNA epigenetic change. In some embodiments, the DNA polymorphism is selected for the group consisting of SNP, STR, VTR, RFLP, deletions, and insertions. In some embodiments, the DNA mutation is selected from the group consisting of point mutations, deletions, and insertions. In some embodiments, the DNA epigenetic change is selected for the group consisting of chemical modifications and chromatin structure. In some embodiments the DNA epigenetic change is a chemical modification. In some embodiments, the chemical modification is DNA methylation.

In some embodiments, the cells in the library of cells are obtained from an individual. In some embodiments, the transcriptional activity of a regulatory element is determined in the genome of said individual. In some embodiments, the transcriptional activity of a regulatory element is correlated with a disease condition.

In some embodiments, the invention provides a method to determine the functional effect of a DNA polymorphism, DNA mutation or DNA epigenetic change in the transcriptional activity of a polynucleotide. The method comprises: (a) providing a first library of cells where the first library comprises cells comprising said DNA polymorphism, DNA mutation or DNA epigenetic change; (b) providing a second library of cells where the second library comprises cells not comprising the DNA polymorphism, DNA mutation or DNA epigenetic change; (c) providing a device comprising a plurality of receptacles, each receptacle containing a different member of the first library of cells or the second library of cells, where each cell in the first and second library of cells comprises a different member of the library of expression constructs, each expression construct comprising a different nucleic acid segment from a genome, where the segment comprises transcription regulatory sequences, operably linked with a heterologous reporter sequence in an expression vector such that expression of the reporter sequence is under transcriptional control of the transcription regulatory sequences; where a plurality comprising at least 20% of the transcription regulatory sequences in the device are part of a common pathway and where each member of the library of cells has a known location among the receptacles; (d) culturing the cells; (e) measuring the level of expression of the reporter sequence in each receptacle; (f) comparing the level of expression of the reporter sequence to each transcription regulatory sequence between the first library of cells and the second library of cells thereby determining the effect of said DNA polymorphism, DNA mutation or DNA epigenetic change in the transcriptions of a polynucleotide.

In some embodiments, the DNA polymorphism is selected for the group consisting of SNP, STR, VTR, RFLP deletions and insertions. In some embodiments, the DNA mutation is selected from the group consisting of point mutations, deletions, and insertions. In some embodiments, the DNA epigenetic change is selected for the group consisting of chemical modifications and chromatin structure. In some embodiments, the DNA epigenetic change is a chemical modification. In some embodiments, the chemical modification is DNA methylation.

In one aspect the invention provides a business method comprising commercializing the compositions, devices of methods described herein.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 schematically illustrates an embodiment of the invention for identifying, isolating and functionally analyzing regulatory elements in a common pathway.

FIG. 2 schematically illustrates an embodiment of the method for detecting transcriptional activity of a plurality of regulatory elements in a high throughput manner.

FIG. 3 schematically illustrates another embodiment of the method for detecting transcriptional activity of a plurality of regulatory elements in a large scale, high throughput manner.

FIG. 4 schematically illustrates an embodiment of the method for large scale, high throughput determination of methylation status of regulatory elements from a common biological pathway.

### DETAILED DESCRIPTION OF THE INVENTION

The present invention relates to the functional measure of gene regulatory elements of specific biological pathways. The present invention relates to high throughput methods for structural and functional characterization of gene expression regulatory elements relevant to biological pathways in a genome of an organism, preferably a mammalian genome, and more preferably a human genome. The inventive methods can be utilized as a high-throughput and easy-to-use system for characterization of the regulatory elements relevant to biological pathways on a large scale, preferably on a genome-wide scale. Compositions, assemblies, libraries, arrays and kits are also provided to allow one to measure the activity of the regulatory elements relevant to biological pathways in the genome in multiple experimental conditions in an efficient and economic way. In some embodiments, promoter microarrays and promoter functional macroarrays are provided for determining transcription factor binding and promoter activity on the same DNA fragment. Such functional libraries or arrays of the regulatory elements can have a wide variety of applications in research, diagnosis, prevention and treatment of diseases or conditions.

In one aspect, by using the invention, the activity of a large number of different regulatory elements can be assessed or determined across diverse cell types or through a differentiation time-course to find tissue-specific and ubiquitous promoters. The activity of the regulatory elements can be detected or determined under different conditions, such as before and after the addition of a siRNA, cDNA, or other compound or drug to identify promoters that are up-regulated or down-regulated in response to a specific treatment. Effects of transcription factors binding to the regulatory element can also be assessed efficiently. The collection of these regulatory elements can be further analyzed for a sequence motif that is functionally relevant, for status of DNA methylation or other epigenetic modifications.

In another aspect, the functional arrays provided by the present invention enables researchers to directly measure the functional activity of promoter fragments relevant to biological pathways that the previous approaches do not. In addition, the spotted promoter arrays or oligo-based promoter arrays also enable chromatin immunoprecipitation and methylation studies to be performed on the exact same promoter fragments and with an integrated computational platform. The integration of multiple types of independent data related to promoter function provides a profoundly new capability in the study of genome-wide transcriptional regulation and specific pathway analysis. This process and methodology allow, for the first time, the simultaneous study of promoter activity, transcription factor binding, and DNA methylation on a large number of regulatory elements relevant to biological pathways throughout the human genome. In addition, this process and methodology allow for identification of compounds or conditions that alter the transcriptional activity of one or more polynucleotides related to a biological pathway.

While not wishing to be bound by theory, it is believed that functional assays are important because although experimental tools like expression microarrays and chromatin immunoprecipitation produce valuable observations, they do not explain the mechanism or measure the direct function of the DNA regulatory elements themselves. Functional data from promoters can show that increased promoter activity and thus increased rates of transcription initiation result in high transcript levels detected in a microarray experiment rather than post-transcriptional mechanisms that stabilize the transcript. Furthermore, the promoter functional assay localizes the activity of interest to a specific DNA fragment and enables the discovery of the exact functional motifs contained in that region.

It is also believed that any one experimental platform alone is not sufficient to fully describe a biological system. A gene may be highly expressed as measured by a microarray based on nucleic acid hybridization, but it cannot be determined why. A transcription factor may bind near a particular gene in the genome, but the functional consequences of binding cannot be determined. A stretch of sequence may be highly conserved, but the reason natural selection has acted to preserve this sequence is unknown. A promoter may be methylated in one cell type and unmethylated in another, but the functional consequences of this difference is not immediately clear. In addition, a promoter may show increased activity in a cell-based functional assay upon the addition of a compound, but one can only make guesses as to why its activity changed without other lines of experimental evidence. Each experimental approach also has its own inherent biases and unique issues related to that particular approach. Thus, the inventors believe that it is only when researchers integrate the information gathered from many diverse techniques they are able to gain a full picture of a biological system, independent of the limitations specific to any one experiment.

The present invention provides an innovative methodology and products to facilitate an integrated approach to regulatory element network analysis relevant to specific biological pathways and use the information generated therefrom for researching the molecular genetic mechanisms of predisposition, onset and/or development of diseases, for development of effective measures for diagnosis, prevention and treatment of diseases.

### I. DEFINITIONS

As used herein, the term “nucleic acid” refers to single-stranded and/or double-stranded polynucleotides such as deoxyribonucleic acid (DNA), and ribonucleic acid (RNA) as well as analogs or derivatives of either RNA or DNA. Also included in the term “nucleic acid” are single-stranded and/or double-stranded polynucleotides as normally found in nature (“natural nucleic acids”), e.g., methylated nucleic acid or unmethylated nucleic acid. Also included in the term “nucleic acid” are analogs of nucleic acids such as peptide nucleic acid (PNA), phosphorothioate DNA, and other such analogs and derivatives or combinations thereof. Thus, the term also should be understood to include, as equivalents, derivatives, variants and analogs of either RNA or DNA made from nucleotide analogs, single (sense or antisense) and double-stranded polynucleotides, including double-stranded RNA. Deoxyribonucleotides include deoxyadenosine, deoxycytidine, deoxyguanosine and deoxythymidine. For RNA, the uracil base is uridine.

As used herein, the term “polynucleotide” refers to an oligomer or polymer containing at least two linked nucleotides or nucleotide derivatives, including a deoxyribonucleic acid (DNA), a ribonucleic acid (RNA), and a DNA or RNA derivative containing, for example, a nucleotide analog or a “backbone” bond other than a phosphodiester bond, for example, a phosphotriester bond, a phosphoramidate bond, a phosphorothioate bond, a thioester bond, or a peptide bond (peptide nucleic acid). The term “oligonucleotide” also is used herein essentially synonymously with “polynucleotide,” although those in the art recognize that oligonucleotides, for example, PCR primers, generally are less than about fifty to one hundred nucleotides in length.

Nucleotide analogs contained in a polynucleotide can be, for example, mass modified nucleotides, which allows for mass differentiation of polynucleotides; nucleotides containing a detectable label such as a fluorescent, radioactive, luminescent or chemiluminescent label, which allows for detection of a polynucleotide; or nucleotides containing a reactive group such as biotin or a thiol group, which facilitates immobilization of a polynucleotide to a solid support. A polynucleotide also can contain one or more backbone bonds that are selectively cleavable, for example, chemically, enzymatically or photolytically. For example, a polynucleotide can include one or more deoxyribonucleotides, followed by one or more ribonucleotides, which can be followed by one or more deoxyribonucleotides, such a sequence being cleavable at the ribonucleotide sequence by base hydrolysis. A polynucleotide also can contain one or more bonds that are relatively resistant to cleavage, for example, a chimeric oligonucleotide primer, which can include nucleotides linked by peptide nucleic acid bonds and at least one nucleotide at the 3′ end, which is linked by a phosphodiester bond or other suitable bond, and is capable of being extended by a polymerase. Peptide nucleic acid sequences can be prepared using well known methods (see, for example, Weiler et al. Nucleic acids Res. 25: 2792-2799 (1997)).

As used herein, to hybridize under conditions of a specified stringency is used to describe the stability of hybrids formed between two single-stranded DNA fragments and refers to the conditions of ionic strength and temperature at which such hybrids are washed, following annealing under conditions of stringency less than or equal to that of the washing step. Typically high, medium and low stringency encompass the following conditions or equivalent conditions thereto:
1) high stringency: 0.1×SSPE or SSC, 0.1% SDS, 65° C.;
2) medium stringency: 0.2×SSPE or SSC, 0.1% SDS, 50° C.;
3) low stringency: 1.0×SSPE or SSC, 0.1% SDS, 50° C.

Equivalent conditions refer to conditions that select for substantially the same percentage of mismatch in the resulting hybrids. Additions of ingredients, such as formamide, Ficoll, and Denhardt's solution affect parameters such as the temperature under which the hybridization should be conducted and the rate of the reaction. Thus, hybridization in 5×SSC, in 20% formamide at 42° C. is substantially the same as the conditions recited above hybridization under conditions of low stringency. The recipes for SSPE, SSC and Denhardt's and the preparation of deionized formamide are described, for example, in Sambrook et al. (1989) Molecular Cloning, A Laboratory Manual, Cold Spring Harbor Laboratory Press, Chapter 8; see, Sambrook et al., vol. 3, p. B.13, see, also, numerous catalogs that describe commonly used laboratory solutions). It is understood that equivalent stringencies can be achieved using alternative buffers, salts and temperatures.

The term “substantially” identical or homologous or similar varies with the context as understood by those skilled in the relevant art and generally means at least 70%, preferably means at least 80%, more preferably at least 90%, and most preferably at least 95% identity.

The term “fragment,” “segment,” or “DNA segment” refers to a portion of a larger DNA polynucleotide or DNA. A polynucleotide, for example, can be broken up, or fragmented into, a plurality of segments. Various methods of fragmenting nucleic acids are well known in the art. These methods may be, for example, either chemical or physical in nature. Chemical fragmentation may include partial degradation with a DNAse; partial depurination with acid; the use of restriction enzymes; intron-encoded endonucleases; DNA-based cleavage methods, such as triplex and hybrid formation methods, that rely on the specific hybridization of a nucleic acid segment to localize a cleaveage agent to a specific location in the nucleic acid molecule; or other enzymes or compounds which cleave DNA at known or unknown locations. Physical fragmentation methods may involve subjecting the DNA to a high shear rate. High shear rates may be produced, for example, by moving DNA through a chamber or channel with pits or spikes, or forcing the DNA sample through a restricted size flow passage, e.g., an aperture having a cross sectional dimension in the micron or submicron scale. Other physical methods include sonication and nebulization. Combinations of physical and chemical fragmentation methods may likewise be employed such as fragmentation by heat and ion-mediated hydrolysis. See for example, Sambrook et al., “Molecular Cloning: A Laboratory Manual,” 3rd Ed. Cold Spring Harbor Laboratory Press, Cold Spring Harbor, N.Y. (2001) (“Sambrook et al.”) which is incorporated herein by reference in its entirety for all purposes. These methods can be optimized to digest a nucleic acid into fragments of a selected size range. Useful size ranges may be from 100, 200, 400, 700 or 1000 to 500, 800, 1500, 2000, 4000 or 10,000 base pairs. However, larger size ranges such as 4000, 10,000 or 20,000 to 10,000, 20,000 or 500,000 base pairs may also be useful.

Methods of ligation will be known to those of skill in the art and are described, for example in Sambrook et al. and the New England BioLabs catalog, both of which are incorporated herein in their entireties by reference for all purposes. Methods include using T4 DNA ligase, which catalyzes the formation of a phosphodiester bond between juxtaposed 5 phosphate and 3′hydroxyl termini in duplex DNA or RNA with blunt or and sticky ends; Taq DNA ligase, which catalyzes the formation of a phosphodiester bond between juxtaposed 5′phosphate and 3′hydroxyl termini of two adjacent oligonucleotides that are hybridized to a complementary target DNA; E. coli DNA ligase, which catalyzes the formation of a phosphodiester bond between juxtaposed 5′-phosphate and 3′-hydroxyl termini in duplex DNA containing cohesive ends; and T4 RNA ligase which catalyzes ligation of a 5′ phosphoryl-terminated nucleic acid donor to a 3′hydroxyl-terminated nucleic acid acceptor through the formation of a 3′->5′ phosphodiester bond, substrates include single-stranded RNA and DNA as well as dinucleoside pyrophosphates; or any other methods described in the art.

“Genome” designates or denotes the complete, single-copy set of genetic instructions for an organism as coded into the DNA of the organism. A genome may be multi-chromosomal such that the DNA is distributed among a plurality of individual chromosomes. For example, in human there are 22 pairs of chromosomes plus a gender associated XX or XY pair.

“Polymorphism” refers to the occurrence of two or more genetically determined alternative sequences or alleles in a population. A polymorphic marker or site is the locus at which divergence occurs. Preferred markers have at least two alleles, each occurring at a frequency of preferably greater than 1%, and more preferably greater than 10% or 20% of a selected population. A polymorphism may comprise one or more base changes, an insertion, a repeat, or a deletion. A polymorphic locus may be as small as one base pair. Polymorphic markers include single nucleotide polymorphisms (SNP's), restriction fragment length polymorphisms (RFLP's), variable number of tandem repeats (VNTR's), hypervariable regions, minisatellites, dinucleotide repeats, trinucleotide repeats, tetranucleotide repeats, simple sequence repeats, and insertion elements such as Alu. The first identified allelic form is arbitrarily designated as the reference form and other allelic forms are designated as alternative or variant alleles. The allelic form occurring most frequently in a selected population is sometimes referred to as the wildtype form. Diploid organisms may be homozygous or heterozygous for allelic forms. A diallelic polymorphism has two forms. A triallelic polymorphism has three forms. A polymorphism between two nucleic acids can occur naturally, or be caused by exposure to or contact with chemicals, enzymes, or other agents, or exposure to agents that cause damage to nucleic acids, for example, ultraviolet radiation, mutagens or carcinogens.

Single nucleotide polymorphisms (SNPs) are positions at which two alternative bases occur in the human population, and are the most common type of human genetic variation. The site is usually preceded by and followed by highly conserved sequences of the allele (e.g., sequences that vary in less than 1/100 or 1/1000 members of the populations). It is estimated that there are as many as 3×106 SNPs in the human genome. Variations that occur at a rate of at least 10% are referred to as common SNPs.

A single nucleotide polymorphism usually arises due to substitution of one nucleotide for another at the polymorphic site. A transition is the replacement of one purine by another purine or one pyrimidine by another pyrimidine. A transversion is the replacement of a purine by a pyrimidine or vice versa. Single nucleotide polymorphisms can also arise from a deletion of a nucleotide or an insertion of a nucleotide relative to a reference allele.

The term genotyping refers to the determination of the genetic information an individual carries at one or more positions in the genome. For example, genotyping may comprise the determination of which allele or alleles an individual carries for a single polymorphism or the determination of which allele or alleles an individual carries for a plurality of polymorphisms.

As used herein, “profiling” refers to detection and/or identification of a plurality of components, generally 3 or more, such as 4, 5, 6, 7, 8, 10, 50, 100, 500, 1000; 10⁴, 105, 10⁶, 10⁷, or more, in a sample. A profile can include the identified loci to which components of a sample detectably bind or are otherwise located. The profile can be detected, e.g., in a multi-well plate, or as a pattern on a solid surface, in which case the profile can be presented as a visual image. The profile can be in the form of a list or database or other such compendium.

As used herein, an image refers to a collection of data points representative of a profile. An image can be a visual, graphical, tabular, matrix or other depiction of such data. It can be stored in a database.

As used herein, a database refers to a collection of data items.

As used herein, in an addressable collection of components of interest, such as a library of transcription regulatory elements (with pre-determined sequences), expression vectors encoding transcription regulatory elements, and cells containing expression vectors encoding transcription regulatory elements, each member of the collection is labeled and/or is positionally located to permit identification of each of member of the components. The addressable collection is typically an array or other encoded (such as bio-barcoded with unique nucleic acid tags) collection in which each locus contains a single, unique component and is identifiable. The collection can be in the liquid phase if other discrete identifiers, such as chemical, electronic, colored, fluorescent or other tags are included.

As used herein, an address refers to a unique identifier whereby an addressed entity can be identified. An addressed moiety is one that can be identified by virtue of its address. Addressing can be effected by position on a surface or by other identifier, such as a tag encoded with a bar code or other symbology, a chemical tag, an electronic, such RF tag, a color-coded tag or other such identifier.

As used herein, a nucleotide barcode refers to a specific type of address, more specifically, predesigned, predetermined and unique nucleotide sequence tag which can be used to uniquely identify each member in a collection of transcription regulatory elements, expression vectors encoding transcription regulatory elements, and cells containing expression vectors encoding transcription regulatory elements. Such a nucleic acid barcode may be 3-200, 5-200, 8-100, or 10-50 nucleotides in length, and discrete and tailorable hybridization and melting properties. Barcodes are heterologous to the molecules they tag.

An “array” comprises a support, preferably solid, comprising a plurality of different, known locations at which an item can be placed. Arrays include, for example, microtiter plates with addressable wells and chips comprising bound molecules at addressable locations. Members of the array may be identified by virtue of an identifiable or detectable label, such as by color, fluorescence, electronic signal (i.e., RF, microwave or other frequency that does not substantially alter the interaction of the molecules of interest), bar code (such as bio-barcode with unique nucleic acid tags) or other symbology, chemical or other such label. For example, the members of the array may be positioned in a container such as a well of a multi-well plate (such as a microtiter plate with 96, 384, or 1536 loci) or a vial, or immobilized to discrete identifiable loci on the surface of a solid phase or directly or indirectly linked to or otherwise associated with the identifiable label, such as affixed to a microsphere or other particulate support (herein referred to as beads) and suspended in solution or spread out on a surface. A microarray, which is used by those of skill in the art, generally is a positionally addressable array, such as an array on a solid support, in which the loci of the array are at high density. Examples of hybridization arrays, also described as “microarrays” or colloquially “chips” have been generally described in the art, for example, U.S. Pat. Nos. 5,143,854, 5,445,934, 5,744,305, 5,677,195, 5,800,992, 6,040,193, 5,424,186 and Fodor et al., Science, 251:767-777 (1991).

Arrays may generally be produced using a variety of techniques, such as mechanical synthesis methods or light directed synthesis methods, that incorporate a combination of photolithographic methods and solid phase synthesis methods. Techniques for the synthesis of these arrays using mechanical synthesis methods are described in, e.g., U.S. Pat. Nos. 5,384,261, and 6,040,193, which are incorporated herein by reference in their entirety for all purposes. Although a planar array surface is preferred, the array may be fabricated on a surface of virtually any shape or even a multiplicity of surfaces. Arrays may be nucleic acids on beads, gels, polymeric surfaces, fibers such as fiber optics, glass or any other appropriate substrate. (See U.S. Pat. Nos. 5,770,358, 5,789,162, 5,708,153, 6,040,193 and 5,800,992.)

As used herein, a support (also referred to as a matrix support, a matrix, an insoluble support or solid support) refers to any solid or semisolid or insoluble support to which an item, e.g., a molecule of interest, typically a biological molecule, organic molecule or biospecific ligand can be linked or contacted. Such materials include any materials that are used as affinity matrices or supports for chemical and biological molecule syntheses and analyses, such as, but are not limited to: polystyrene, polycarbonate, polypropylene, nylon, glass, dextran, chitin, sand, pumice, agarose, polysaccharides, dendrimers, buckyballs, polyacrylamide, silicon, rubber, and other materials used as supports for solid phase syntheses, affinity separations and purifications, hybridization reactions, immunoassays and other such applications. The matrix herein can be particulate or can be a be in the form of a continuous surface, such as a microtiter dish or well, a glass slide, a silicon chip, a nitrocellulose sheet, nylon mesh, or other such materials.

As used herein, matrix or support particles refer to matrix materials that are in the form of discrete particles. The particles have any shape and dimensions, but typically have at least one dimension that is 100 μm or less, 50 μm or less and typically have a size that is 100 mm³ or less, 50 mm³ or less, 10 mm³ or less, and 1 mm³ or less, 100 μm³ or less and may be order of cubic microns. Such particles are collectively called “beads.” They are often, but not necessarily, spherical. Such reference, however, does not constrain the geometry of the matrix, which can be any shape, including random shapes, needles, fibers, and elongated. Roughly spherical “beads”, particularly microspheres that can be used in the liquid phase, are also contemplated. The “beads” can include additional components, such as magnetic or paramagnetic particles (see, e.g., Dyna beads (Dynal, Oslo, Norway)) for separation using magnets, as long as the additional components do not interfere with the methods and analyses herein.

As used herein, a “library” is a collection of items. In certain embodiments the library is “addressable,” i.e., members of the library comprise an identifying tag or are physically located at a different, discrete, known locations, such as contained within different wells of a multi-well plate or different containers.

As used herein, “array library” refers to the collections of addressable elements or components created by physical separation of the mixed library into a number of discrete collections.

As used herein, biological sample refers to any sample obtained from a living or viral source and includes any cell type or tissue of a subject from which nucleic acid or protein or other macromolecule can be obtained. Biological samples include, but are not limited to, cell lysates, cells, body fluids, such as blood, plasma, serum, cerebrospinal fluid, synovial fluid, urine and sweat, tissue and organ samples from animals and plants, such as humans, non-human mammals such as monkeys, dogs, pigs, horses, cats, rabbits, rats, and mice, and other vertebrates such as birds and fish. Also included are soil and water samples and other environmental samples, viruses, bacteria, fungi algae, protozoa and components thereof. The methods herein can be practiced using biological samples and in some embodiments, such as for profiling, can also be used for testing any sample.

As used herein, “a reporter gene construct” is a nucleic acid molecule that includes a nucleic acid encoding a reporter operatively linked to a transcriptional control sequence. Transcription of the reporter gene is controlled by these sequences. The activity of at least one or more of these control sequences is directly or indirectly regulated by transcription factors and other proteins or biomolecules. The transcriptional control sequences include the promoter and other regulatory regions, such as enhancer sequences, that modulate the activity of the promoter, or control sequences that modulate the activity or efficiency of the RNA polymerase that recognizes the promoter, or control sequences are recognized by effector molecules. Such sequences are herein collectively referred to as transcriptional regulatory elements or sequences.

As used herein, “reporter” or “reporter moiety” refers to any moiety that allows for the detection of a molecule of interest, such as a protein expressed by a cell, or a biological particle. Typical reporter moieties include, include, for example, light emitting proteins such as luciferase, fluorescent proteins, such as red, blue and green fluorescent proteins (see, e.g., U.S. Pat. No. 6,232,107, which provides GFPs from Renilla species and other species), the lacZ gene from E. coli, alkaline phosphatase, secreted embryonic alkaline phosphatase (SEAP), chloramphenicol acetyl transferase (CAT), hormones and cytokines and other such well-known genes. For expression in cells, nucleic acid encoding the reporter moiety can be expressed as a fusion protein with a protein of interest or under to the control of a promoter of interest. The expression of these reporter genes can also be monitored by measuring levels of mRNA transcribed from these genes.

“Operatively linked” or “operably linked” refers to a functional arrangement of elements wherein the activity of one element (e.g., a promoter) results on an action on the other element (e.g., a nucleotide sequence). Thus, a given promoter that is operably linked to a coding sequence (e.g., a reporter gene) is capable of effecting the expression of the coding sequence when the proper enzymes are present. The promoter or other control elements need not be contiguous with the coding sequence, so long as they function to direct the expression thereof. For example, intervening untranslated yet transcribed sequences can be present between the promoter sequence and the coding sequence and the promoter sequence can still be considered “operably linked” to the coding sequence.

As used herein, regulatory molecule refers to a polymer of deoxyribonucleic acid (DNA) or ribonucleic acid (RNA), or an oligonucleotide mimetic, or a polypeptide or other molecule that is capable of enhancing or inhibiting expression of a gene.

As used herein, the terms “transcription regulatory region” or “transcription regulatory sequence” mean a nucleotide sequence that influences expression, positively or negatively, of an operatively linked gene. Regulatory regions include sequences of nucleotides that confer inducible (i.e., require a substance or stimulus for increased transcription) expression of a gene. When an inducer is present, or at increased concentration, gene expression increases. Regulatory regions also include sequences that confer repression of gene expression (i.e., a substance or stimulus decreases transcription). When a repressor is present or at increased concentration, gene expression decreases. Regulatory regions are known to influence, modulate or control many in vivo biological activities including cell proliferation, cell growth and death, cell differentiation and immune-modulation. Regulatory regions typically bind one or more trans-acting proteins which results in either increased or decreased transcription of the gene. In certain embodiments, the regulatory regions are cis-acting.

Particular examples of gene regulatory regions are promoters and enhancers. Promoters are sequences located around the transcription start site, typically positioned 5′ of the transcription start site. Enhancers are known to influence gene expression when positioned 5′ or 3′ of the gene, or when positioned in or a part of an exon or an intron. Enhancers also can function at a significant distance from the gene, for example, at a distance from about 3 Kb, 5 Kb, 7 Kb, 10 Kb, 15 Kb or more.

As used herein, a promoter region refers to the portion of DNA of a gene that controls transcription of the DNA to which it is operatively linked. The promoter region includes specific sequences of DNA that are sufficient for RNA polymerase recognition, binding and transcription initiation. This portion of the promoter region is referred to as the core promoter. In addition, the promoter region includes sequences that modulate this recognition, binding and transcription initiation activity of the RNA polymerase. These sequences can be cis acting or can be responsive to trans acting factors. Promoters, depending upon the nature of the regulation, can be constitutive or regulated.

Regulatory regions also include, in addition to promoter regions, sequences that facilitate translation, transcript stability, splicing signals for introns, maintenance of the correct reading frame of the gene to permit in-frame translation of mRNA, leader sequences and fusion partner sequences, internal ribosome binding sites (IRES) elements for the creation of multigene, or polycistronic, messages, polyadenylation signals to provide proper polyadenylation of the transcript of a gene of interest and stop codons and can be optionally included in an expression vector.

As used herein, a composition refers to any mixture. It can be a solution, a suspension, liquid, powder, a paste, aqueous, non-aqueous or any combination thereof.

As used herein, a combination refers to any association between among two or more items. The combination can be two or more separate items, such as two compositions or two collections, can be a mixture thereof, such as a single mixture of the two or more items, or any variation thereof.

As used herein, a kit refers to a packaged combination, optionally including instructions and/or reagents for their use.

As used herein, two nucleic acid segments are “heterologous” with respect to each other if their sequences are not found in the same genome or are not normally linked to one another within 10000 nucleotides in the same genome.

As used herein, a nucleic acid molecule is “isolated” if it is removed from its natural milieu in a genome and/or cell.

A nucleic acid molecule is “pure” or “purified” if it is the predominant biomolecular species in a mixture.

### II. BIOLOGICAL PATHWAYS

In one aspect, the present invention relates to the functional measure of the regulation of genes of a common pathway. Genes belong to a common pathway when they share one or more attributes in common in a gene ontology, a collection that assigns defined characteristics to a set of genes. The ontology administered by the Gene Ontology (“GO”) Consortium is particularly useful in this regard. Genes belonging to common pathways can be identified by searching a gene ontology, such as GO, for genes sharing one or more attributes. The common attribute could be, for example, a common structural feature, a common location, a common biological process or a common molecular function.

The wealth of information that exists in published, peer-reviewed literature concerning the function of human genes and proteins has been organized and curated using a coordinated system of controlled vocabulary that is administered by the Gene Ontology (GO) Consortium (http://www.geneontology.org/). The GO project has developed three structured controlled vocabularies (ontologies) that describe gene products in terms of their associated biological processes, cellular components and molecular functions in a species-independent manner. There are three separate aspects to this effort: first, the development and maintenance of the ontologies themselves; second, the annotation of gene products, which entails making associations between the ontologies and the genes and gene products in the collaborating databases; and third, development of tools that facilitate the creation, maintenance and use of ontologies. Of the approximately 40,000 transcribed units in the human genome, approximately 20,000 of those code for annotated proteins, and approximately 14,000 of those proteins have a functional annotation in the GO database. The functional annotations contained in the GO database are organized in a hierarchical manner, and it is possible to access this information from the GO database and search for all of the genes in the human genome that are annotated to be involved in the same biological process, reside in the same cellular component, or perform the same molecular function.

In some embodiments, transcription regulatory sequences in a common pathway are regulatory elements that control the expression of genes involved in the same biological process or molecular function as annotated by a gene ontology. One example of this is transcription regulatory sequences that control the expression of genes involved in the response to DNA damage.

In some embodiments, transcription regulatory sequences in a common pathway are regulatory elements that are all bound by the same transcription factor protein, complex of transcription factor proteins, other nucleic acid binding proteins, or other molecule. These interactions may occur in a living cell (in vivo) or in a solution of purified molecules (in vitro). For instance, all of the regulatory elements bound by the hypoxia inducible transcription factor protein.

In some embodiments, transcription regulatory sequences in a common pathway are regulatory elements that control the expression of genes whose transcript levels or proteins levels change upon treatment or exposure to the same stimulus and are thus co-regulated. For example all of the regulatory elements whose transcripts are induced or repressed upon treatment to UV radiation.

In some embodiments, transcription regulatory sequences in a common pathway are regulatory elements that contain similar sequence features. These features may be a DNA sequence motif, collection of DNA sequence motifs, or enrichment of higher order sequence features that are distinguishable from a background model of random genomic sequences. As used herein, a sequence motif is a string of 2 or more nucleic acid bases (A, T, C, or G). A DNA sequence motif can either be defined by a consensus sequence or a probability matrix where the identity of each base at each position of a motif is defined as a probability.

In some embodiments, transcription regulatory sequences in a common pathway could be regulatory elements that control the expression of genes whose sequences, transcripts or proteins are connected via metabolic transformations and/or physical protein-protein, protein-DNA and protein-compound interactions. Enzymes catalyze these reactions, and often require dietary minerals, vitamins and other cofactors in order to function properly. Because of the many chemicals that may be involved, pathways can be quite elaborate.

In some embodiments, the members of the pathway share a common structural or functional attribute. For example, the proteins could share a common sequence motif, such as a zinc finger or a transmembrane region.

In some embodiments, the genes in a common pathway belong to the same signal transduction pathway. Typically, in biology signal transduction refers to any process by which a cell converts one kind of signal or stimulus into another, most often involving ordered sequences of biochemical reactions inside the cell that are carried out by enzymes, activated by second messengers resulting in what is thought of as a signal transduction pathway. Usually, signal transduction involves the binding of extracellular signaling molecules (or ligands) to cell-surface receptors that face outwards from the plasma membrane and trigger events inside the cell. Additionally, intracellular signaling cascades can be triggered through cell-substratum interactions, as in the case of integrins which bind ligands found within the extracellular matrix. Steroids represent another example of extracellular signaling molecules that may cross the plasma membrane due to their lipophilic or hydrophobic nature. Many steroids, but not all, have receptors within the cytoplasm and usually act by stimulating the binding of their receptors to the promoter region of steroid responsive genes. Within multicellular organisms there are a diverse number of small molecules and polypeptides that serve to coordinate a cell's individual biological activity within the context of the organism as a whole. Examples of these molecules include hormones (e.g. melatonin), growth factors (e.g. epidermal growth factor), extra-cellular matrix components (e.g. fibronectin), cytokines (e.g. interferon-gamma), chemokines (e.g. RANTES), neurotransmitters (e.g. acetylcholine), and neurotrophins (e.g. nerve growth factor).

In addition to many of the regular signal transduction stimuli listed above, in complex organisms, there are also examples of additional environmental stimuli that initiate signal transduction processes. Environmental stimuli may also be molecular in nature or more physical, such as, light striking cells in the retina of the eye, odorants binding to odorant receptors in the nasal epithelium, bitter and sweet tastes stimulating taste receptors in the taste buds, UV light altering DNA in a cell, and hypoxia activating a series of events in cells. Certain microbial molecules e.g. viral nucleotides, bacterial lipopolysaccharides, or protein antigens are able to elicit an immune system response against invading pathogens, mediated via signal transduction processes.

Activation of genes, alterations in metabolism, the continued proliferation and death of the cell, and the stimulation or suppression of locomotion, are some of the cellular responses to extracellular stimulation that require signal transduction. Gene activation leads to further cellular effects, since the protein products of many of the responding genes include enzymes and transcription factors themselves. Transcription factors produced as a result of a signal transduction cascade can in turn activate yet more genes. Therefore an initial stimulus can trigger the expression of an entire cohort of genes, and this in turn can lead to the activation of any number of complex physiological events. These events include, for example, the increased uptake of glucose from the blood stream stimulated by insulin and the migration of neutrophils to sites of infection stimulated by bacterial products.

Most mammalian cells require stimulation to control not only cell division, but also survival. In the absence of growth factor stimulation, programmed cell death ensues in most cells. Such requirements for extra-cellular stimulation are necessary for controlling cell behavior in both the context of unicellular and multi-cellular organisms. Signal transduction pathways are so central to biological processes that it is not surprising that a large number of diseases have been attributed to their dysregulation.

a. Oncology Pathway

In some embodiments, the invention provides methods and compositions including transcription regulatory sequences that are part of an oncology pathway. Transcription regulatory sequences in an oncology pathway are those that control the expression of genes involve in the development of hyperplasia, neoplasia and/or cancer. Examples of oncology pathways include, but are not limited to, hypoxia, DNA damage, apoptosis, cell cycle, and p53 pathway.

In some embodiments, the invention allows for the determination of the transcriptional regulatory activity of a plurality of different nucleic acid segments that are part of an oncology pathway under a variety of conditions. In some embodiments, the methods described herein allow for the determination of the base present at a polymorphism of a transcriptional regulatory element in the genome of an individual and whether that polymorphism is associated with a change in the function of that element and/or other regulatory element(s) in the genome. In some embodiments, the methods described herein allow for the determination of transcriptional activity of a plurality of transcriptional regulatory elements that are part of an oncology pathway in the genome of an individual.

The methods and compositions described herein enable a better understanding, diagnosing and treatment of a disease or condition associated with aberrant transcriptional activity of an oncology regulatory element, such as Acute Lymphoblastic Leukemia, Acute Myeloid Leukemia, Adrenocortical Carcinomas, AIDS-Related Cancers, AIDS-Related Lymphomas, Anal Cancers, Astrocytomas, Bladder Cancers, Brain Tumors, Bone Cancers, Melanomas, Breast Cancers, Non-Hodgkin's, CNS and other Lymphomas, Cervical Cancer, Cancers of Unknown Primary causes, Colon and Rectal Cancer, Pancreatic Cancer, Endometrial Cancer, Esophageal Cancer, Eye Cancers, Germ Cell Cancers, Gliomas, Gastric Cancers, Head and Neck Cancers, Prostate Cancer, Kaposi's Sarcoma, Kidney (Renal Cell) Cancers, Skin Cancer, Leukemia, Laryngeal Cancers, Lip and Oral Cancers, Ovarian Cancers, Soft Tissue Cancers, Testicular Cancer, Thyroid Cancer, Uterine Cancer, Vaginal Cancer, Lung Cancer and other oncology diseases/disorders in general.

In some embodiments, the invention provides methods and compositions including transcription regulatory sequences that are part of a hypoxia pathway. The methods described herein enable a better understanding, diagnosing and treatment of a disease or condition associated with aberrant transcriptional activity of a hypoxia-related regulatory element, such as cancer, anemia, erythropoiesis, rheumatoid arthritis, DVT, chronic inflammatory bowel disease, ischemias, chronic bronchitis, psoriasis, cystic fibrosis and other inflammatory, pulmonary or vasculapathic diseases in general.

b. Membrane Pathway

In some embodiments, the invention provides methods and compositions including transcription regulatory sequences that are part of a membrane pathway. Examples of membrane pathways include, but are not limited to, transport proteins, G-coupled receptors, ion channels, cell adhesion proteins and receptors pathways.

In some embodiments, the invention allows for the determination of transcriptional regulatory activity of a plurality of different nucleic acid segments that are part of a membrane pathway under a variety of conditions. In some embodiments, the methods described herein allow for the determination of the base present at a polymorphism of a transcriptional regulatory element in the genome of an individual and whether that polymorphism is associated with a change in the function of that element and/or other regulatory element(s) in the genome. In some embodiments, the methods described herein allow for the determination of transcriptional activity of a plurality of transcriptional regulatory elements that are part of a membrane pathway in the genome of an individual.

The methods described herein enable a better understanding, diagnosing, and treatment of a disease or condition associated with aberrant transcriptional activity of a regulatory element in a membrane pathway, such as altered drug responses or metabolism, abnormal changes in signaling pathways, changes in responses to external or internal stimuli such as small molecules, hormones, toxins, infection, environmental changes, and other membrane- or signaling-associated diseases/disorders in general.

c. Nuclear Receptor Pathways

In some embodiments, the invention provides methods and compositions including transcription regulatory sequences that are part of a nuclear receptor pathway. Examples of regulatory elements in a nuclear receptor pathway include, but are not limited to, DNA elements that are regulated by the glucocorticoid receptor protein, estrogen receptor protein, peroxisome proliferator-activated receptor protein, androgen receptor protein and transporter protein pathways, including ABC and SLC transporters.

In some embodiments, the invention allows for the determination of transcriptional regulatory activity of a plurality of different nucleic acid segments that are part of a nuclear receptor pathway under a variety of conditions. In some embodiments, the methods described herein allow for the determination of the base present at a polymorphism of a transcriptional regulatory element in the genome of an individual and whether that polymorphism is associated with a change in the function of that element and/or other regulatory element(s) in the genome. In some embodiments, the methods described herein allow for the determination of transcriptional activity of a plurality of transcriptional regulatory elements that are part of a nuclear receptor pathway in the genome of an individual.

The methods described herein enable a better understanding, diagnosing, and treatment of a disease or condition associated with aberrant transcriptional activity of a regulatory element in a nuclear receptor pathway, such as cancer, diabetes, lipid metabolism, aberrant hormone response, rheumatoid arthritis, chronic inflammation, pulmonary or cardiovascular diseases in general.

d. Neuronal Pathway;

In some embodiments, the invention provides methods and compositions including transcription regulatory sequences that are part of a neuronal pathway. Examples of regulatory elements in a neuronal pathway include, but not limited to, regulatory elements involved in regulation of genes expressed in neurons such as neurotransmitters and cell adhesion proteins.

In some embodiments, the invention allows for the determination of transcriptional regulatory activity of a plurality of different nucleic acid segments that are part of a neuronal pathway under a variety of conditions. In some embodiments, the methods described herein allow for the determination of the base present at a polymorphism of a transcriptional regulatory element in the genome of an individual and whether that polymorphism is associated with a change in the function of that element and/or other regulatory element(s) in the genome. In some embodiments, the methods described herein allow for the determination of transcriptional activity of a plurality of transcriptional regulatory elements that are part of a neuronal pathway in the genome of an individual.

The methods described herein enable a better understanding, diagnosing, and treatment of a disease or condition associated with aberrant transcriptional activity of a neuronal regulatory element, such as Alzheimer's, Parkinson's, stroke, dystonias, phobias, depression, amyotrophic lateral sclerosis (ALS), multiple sclerosis, dyslexia, tourette's, phantom limbs, Meniere's Disease, encephelopathic diseases, migraines, narcolepsy, paralysis disorders, autism, cerebral palsy, corticobasal degeneration, comas, cerebral atrophy, Creutzfeldt-Jakob Disease, epilepsy, Huntington's, brain tumors, AIDS dementia, Gaucher's disease, Bell's palsy, aphasias and other neurological diseases/disorders in general.

e. Vascular Pathway

In some embodiments, the invention provides methods and compositions including transcription regulatory sequences that are part of a vascular pathway. Examples of regulatory elements in a vascular pathway include, but not limited to, regulatory elements involved in angiogenesis, lipid metabolism, and inflammation.

In some embodiments, the invention allows for the determination of transcriptional regulatory activity of a plurality of different nucleic acid segments that are part of a vascular pathway under a variety of conditions. In some embodiments, the methods described herein for the determination of the base present at a polymorphism of a transcriptional regulatory element in the genome of an individual and whether that polymorphism is associated with a change in the function of that element and/or other regulatory element(s) in the genome. In some embodiments, the methods described herein allow for the determination of transcriptional activity of a plurality of transcriptional regulatory elements that are part of a vascular pathway in the genome of an individual.

The methods described herein enable a better understanding, diagnosing, and treatment of a disease or condition associated with aberrant transcriptional activity of a vascular regulatory element, such as Acrocyanosis, Angina, Arteriovenous Disorders, Atherosclerosis, Atrial Disorders, Cardiac Disorders, Cavernous Malformations, Congestive Heart Disease, Fistula Buerger's Disease, Coronary Artery Diseases, Central Venous Insufficiency, Deep Vein Thrombosis (DVT), Erythromelalgia, Gangrene, Heart Attacks, Hemorrhagic Diseases, Ischemic Diseases, Klippel-Trenaunay Syndrome, Lymphedema and Lipedema, Peripheral Vascular/Arterial Disease, Raynaud's Disease, Stroke, Thrombosis, Thrombophlebitis/Phlebitis, Varicose and Spider Veins, Vascular Birthmark, Vasculitis and other vascular diseases/disorders in general.

f. Transcription Factors Pathway

In some embodiments, the invention provides methods and compositions including transcription regulatory sequences that are part of a transcription factor pathway. Examples of regulatory elements in a transcription factor pathway include, but are not limited to, regulatory elements of genes that code for proteins that regulate the expression of other genes either by direct DNA binding or indirect interactions with other transcriptional regulators.

In some embodiments, the invention allow for the determination of transcriptional regulatory activity of a plurality of different nucleic acid segments that are part of a transcription factor pathway under a variety of conditions. In some embodiments, the methods described herein allow for the determination of the base present at a polymorphism of a transcriptional regulatory element in the genome of an individual and whether that polymorphism is associated with a change in the function of that element and/or other regulatory element(s) in the genome. In some embodiments, the methods described herein allow for the determination of transcriptional activity of a plurality of transcriptional regulatory elements that are part of a neuronal pathway in the genome of an individual.

The methods described herein enable a better understanding, diagnosing, and treatment of a disease or condition associated with aberrant transcriptional activity of a transcription factor gene regulatory element, such as cancer, heart disease, obesity, abnormal immune response, inflammation, neurological disorders, drug response, and drug metabolism.

g. Signaling Pathway

In some embodiments, the invention provides methods and compositions including transcription regulatory sequences that are part of a signaling pathway. Examples of regulatory elements in a signaling pathway include, but are not limited to, regulatory elements of genes involved in cell-to-cell signaling, hormones, hormone receptors, cAMP response, and cytokines.

In some embodiments, the invention allows for the determination of transcriptional regulatory activity of a plurality of different nucleic acid segments that are part of a signaling pathway under a variety of conditions. In some embodiments, the methods described herein allow for the determination of the base present at a polymorphism of a transcriptional regulatory element in the genome of an individual and whether that polymorphism is associated with a change in the function of that element and/or other regulatory element(s) in the genome. In some embodiments, the methods described herein allow for the determination of transcriptional activity of a plurality of transcriptional regulatory elements that are part of a signaling pathway in the genome of an individual.

h. Enzymatic Pathway

In some embodiments, the invention provides methods and compositions including transcription regulatory sequences that are part of an enzymatic pathway. Examples of regulatory elements in a enzymatic pathway include, but are not limited to, regulatory elements of genes involved in glycolysis, anaerobic respiration, Krebs cycle/Citric acid cycle, Oxidative phosphorylation, fatty acid oxidation (β-oxidation), gluconeogenesis, HMG-CoA reductase pathway, pentose phosphate pathway, porphyrin synthesis (or heme synthesis) pathway, urea cycle, photosynthesis (plants, algae, cyanobacteria) and chemosynthesis (some bacteria).

In some embodiments, the invention allows for the determination of transcriptional regulatory activity of a plurality of different nucleic acid segments that are part of a enzymatic pathway under a variety of conditions. In some embodiments, the methods described herein allow for the determination of the base present at a polymorphism of a transcriptional regulatory element in the genome of an individual and whether that polymorphism is associated with a change in the function of that element and/or other regulatory element(s) in the genome. In some embodiments, the methods described herein allow for the determination of transcriptional activity of a plurality of transcriptional regulatory elements that are part of an enzymatic pathway in the genome of an individual.

The methods described herein enable a better understanding, diagnosing, and treatment of a disease or condition associated with aberrant transcriptional activity of a signaling regulatory element, such as Diabetes, Oncology diseases, Glycogen storage diseases, Obesity, Fatty Oxidation disorders, Mitochondrial disorders, Starvation, Dehydration, Channelopathies (disorders that affect ion channels and organelle membranes), Myoadenylate Deaminase deficiency, Carnitine disorders, Galactosemias, Fucosidosis, Rickets, Tyrosinemias, Lysosomal Storage disease, Hyponatermia, Hyperlipidemia, Hypercalcemia, Iodine deficiency, Anemia, Wernicke's Disease, vitamin deficiencies, Wolman Disease and other metabolic diseases/disorders in general

### III. LIBRARIES OF TRANSCRIPTION REGULATORY ELEMENTS

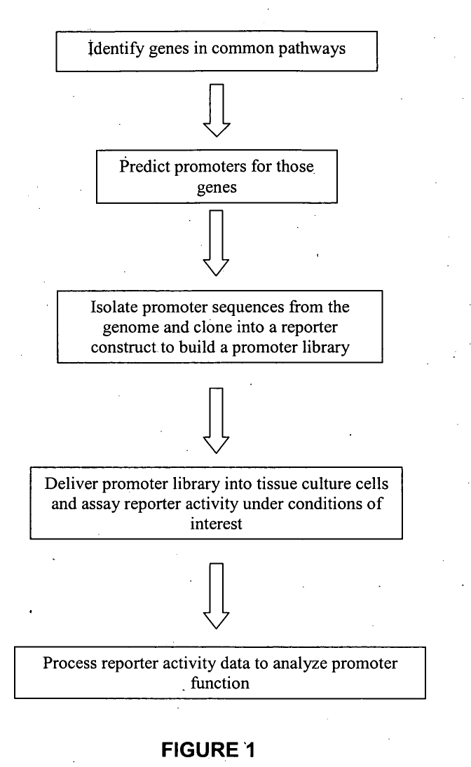

In one aspect, this invention provides a library of genomic nucleic acid segments comprising transcription regulatory elements relevant to biological pathways in a genome of an organism. The libraries of this invention are characterized by, among other things, the length of the segments that populate the library and the high percentage of segments in which the transcriptional regulatory elements naturally control the transcription of genes with biological function (e.g. genes that play a biological role in an organism). In one embodiment, the human genomic segments of this invention can be selected using the method that is described in FIG. 1, and more fully described in the examples. In particular, the transcription regulatory sequences or the libraries of this invention can be selected from those described in United States patent publication 2007/0161031 (Trinklein et al. Jul. 12, 2007).

Each genomic nucleic acid segment selected for the library can be operatively linked in nature with a sequence in the genome that aligns with a known cDNA molecule. The library comprises a low percentage of segments (e.g., less than 30%, 25%, 20%, 15%, 10%, 5%, 2%, or 1%) that are linked to cDNA alignment artifacts. These artifacts result from inaccuracies of the alignment algorithm or from genomic DNA contamination of the original cDNA libraries that were sequenced. These artifacts are identified as intronless (ungapped) alignments represented by a small number of independent cDNAs from existing cDNA libraries, as pseudogenes and as single exon genes. More specifically, a library of genetic sequences, such a GenBank, contains a number of molecules reported as cDNAs. When these sequences are aligned against the sequence of the genome, certain locations of the genome are mapped by many reported cDNAs, so that the alignment cannot be considered random: One can be highly confident that these locations represent biologically relevant cDNAs and that the up-stream sequences are active transcription regulatory sequences. Other locations in the genome are mapped by few reported cDNAs or none. If the cDNA sequences are unspliced (that is they contain no introns) and the number of cDNAs mapping to a location in the genome is no more than what one would expect under a random model, then these alignments are considered artifacts.

The segments of the libraries of this invention also function well in regulating transcription because, among other things, they contain sequences involved in regulation of transcription. In some embodiments, the libraries of this invention include segments having an average length of at least 10, 20, 30, 50, 60, 70, 80, 90, 100, 200, 300, 400, 500, or 600 nucleotides. In some embodiments, the libraries of this invention include segments having an average length of at least 600 nucleotides. In certain embodiments, the average length of segments in the library is between 700 nucleotides and 1200 nucleotides. In some embodiments, the average length can be between 800 nucleotides and 1100 nucleotides or between 950 nucleotides and 1050 nucleotides. Furthermore, the segments in the library can have a range of different lengths. For example, in one embodiment, at least 90% of the segments have lengths ranging from 200 to 1300 nucleotides or between 700 nucleotides and 1300 nucleotides. In another embodiment no more than 5% of the nucleic acid segments are naturally linked to cDNA alignment artifacts. Each segment contains a start site for transcription.

In some embodiments, most of the genomic sequence of the segments is up-stream of the transcriptional start site, typically at least 500 base pairs. The segments typically have at least one nucleotide beyond the transcriptional start site and a majority have approximately 100 nucleotides downstream of the transcriptional start site.

The present invention also provides a library of transcription regulatory elements, e.g., a library of transcriptional promoters, preferably with diversity of at least 5, 10, 20, 30, 40, 50, optionally at least 80, 120, 160, 200, 400, 500, 600, 800, 1000, 1500, 2000, 3000, 5000, 8000, or 10,000. Examples of transcriptional promoters include, but are not limited to, at least 2, optionally at least 5, 10, 20, 50, 100, 200, 500, 1000, 5000, 10000, or 25000 nucleotides selected from the group consisting of SEQ ID NO: 1-3836, or fragments thereof, such as fragments of SEQ ID NO: 1-3836 of about 100-1800, about 300-1500, about 500-1400, about 600-1300, about 700-1200, or about 800-1000 nucleotide in length, or nucleic acids having sequences with at least 70%, 75%, 80%, 85%, 90%, 95%, or 98% homology thereto. Examples of transcriptional promoters include, but are not limited to, at least 2, optionally at least 5, 10, 20, 50, 100, 200, 500, 1000, 5000, 10000, or 25000 nucleotides selected from the group consisting of SEQ ID NO: 3837-12716, or fragments thereof, such as fragments of SEQ ID NO: 3837-12716 of about 100-1800, about 300-1500, about 500-1400, about 600-1300, about 700-1200, or about 800-1000 nucleotide in length, or nucleic acids having sequences with at least 70%, 75%, 80%, 85%, 90%, 95%, or 98% homology thereto. Examples of transcriptional promoters include, but are not limited to, at least 2, optionally at least 5, 10, 20, 50, 100, 200, 500, 1000, 5000, 10000, or 25000 nucleotides selected from the group consisting of SEQ ID NO: 12717-13994, or fragments thereof, such as fragments of SEQ ID NO: 12717-13994 of about 100-1800, about 300-1500, about 500-1400, about 600-1300, about 700-1200, or about 800-1000 nucleotide in length, or nucleic acids having sequences with at least 70%, 75%, 80%, 85%, 90%, 95%, or 98% homology thereto.

The present invention also provides a library of transcription regulatory elements in which at least 5%, 10%, 20%, 30%, 40%, 50%, 60%, 70%, 80%, 90%, 99% or 100% of the regulatory elements are part of a common pathway.

In some embodiments, the invention provides a library of transcription regulatory elements in which at least 5%, 10%, 20%, 30%, 40%, 50%, 60%, 70%, 80%, 90%, 99% or 100% of the regulatory elements are part of an oncology pathway. In some embodiments, the invention provides a library of transcription regulatory elements in which at least 5%, 10%, 20%, 30%, 40%, 50%, 60%, 70%, 80%, 90%, 99% or 100% of the regulatory elements are part of a hypoxia pathway. In some embodiments, the invention provides a library of transcription regulatory elements in which at least 5%, 10%, 20%, 30%, 40%, 50%, 60%, 70%, 80%, 90%, 99% or 100% of the regulatory elements are part of a DNA-damage pathway. In some embodiments, the invention provides a library of transcription regulatory elements in which at least 5%, 10%, 20%, 30%, 40%, 50%, 60%, 70%, 80%, 90%, 99% or 100% of the regulatory elements are part of an apoptosis pathway. In some embodiments, the invention provides a library of transcription regulatory elements in which at least 5%, 10%, 20%, 30%, 40%, 50%, 60%, 70%, 80%, 90%, 99% or 100% of the regulatory elements are part of a cell cycle pathway. In some embodiments, the invention provides a library of transcription regulatory elements in which at least 5%, 10%, 20%, 30%, 40%, 50%, 60%, 70%, 80%, 90%, 99% or 100% of the regulatory elements are part of a p53 pathway. In some embodiments, the inventions provides a library of transcription regulatory elements in which at least 5%, 10%, 20%, 30%, 40%, 50%, 60%, 70%, 80%, 90%, 99% or 100% of the regulatory elements are differently selected from the group consisting of hypoxia pathway, DNA-damage pathway, apoptosis pathway, cell cycle pathway, and p53 pathway

In some embodiments, the invention provides a library of transcription regulatory elements in which at least 5%, 10%, 20%, 30%, 40%, 50%, 60%, 70%, 80%, 90%, 99% or 100% of the regulatory elements are part of a membrane bound pathway.

In some embodiments, the invention provides a library of transcription regulatory elements in which at least 5%, 10%, 20%, 30%, 40%, 50%, 60%, 70%, 80%, 90%, 99% or 100% of the regulatory elements are part of a nuclear receptor pathway. In some embodiments, the invention provides a library of transcription regulatory elements in which at least 5%, 10%, 20%, 30%, 40%, 50%, 60%, 70%, 80%, 90%, 99% or 100% of the regulatory elements are part of a glucocorticoid receptor pathway. In some embodiments, the invention provides a library of transcription regulatory elements in which at least 5%, 10%, 20%, 30%, 40%, 50%, 60%, 70%, 80%, 90%, 99% or 100% of the regulatory elements are part of a peroxisome proliferator-activated receptor pathway. In some embodiments, the invention provides a library of transcription regulatory elements in which at least 5%, 10%, 20%, 30%, 40%, 50%, 60%, 70%, 80%, 90%, 99% or 100% of the regulatory elements are part of an estrogen receptor pathway. In some embodiments, the invention provides a library of transcription regulatory elements in which at least 5%, 10%, 20%, 30%, 40%, 50%, 60%, 70%, 80%, 90%, 99% or 100% of the regulatory elements are part of an androgen receptor pathway. In some embodiments, the invention provides a library of transcription regulatory elements in which at least 5%, 10%, 20%, 30%, 40%, 50%, 60%, 70%, 80%, 90%, 99% or 100% of the regulatory elements are part of a cytochrome P450 receptor pathway. In some embodiments, the invention provides a library of transcription regulatory elements in which at least 5%, 10%, 20%, 30%, 40%, 50%, 60%, 70%, 80%, 90%, 99% or 100% of the regulatory elements are part of a transporter receptor pathway. In some embodiments, the invention provides a library of transcription regulatory elements in which at least 5%, 10%, 20%, 30%, 40%, 50%, 60%, 70%, 80%, 90%, 99% or 100% of the regulatory elements are differently selected from the group consisting of glucocorticoid receptor pathway, peroxisome proliferator-activated receptor pathway, estrogen receptor pathway, androgen receptor pathway, cytochrome P450 pathway, and transporter pathways

In some embodiments, the invention provides a library of transcription regulatory elements in which at least 5%, 10%, 20%, 30%, 40%, 50%, 60%, 70%, 80%, 90%, 99% or 100% of the regulatory elements are part of a vascular pathway. In some embodiments, the invention provides a library of transcription regulatory elements in which at least 5%, 10%, 20%, 30%, 40%, 50%, 60%, 70%, 80%, 90%, 99% or 100% of the regulatory elements are part of a neuronal pathway. In some embodiments, the invention provides a library of transcription regulatory elements in which at least 5%, 10%, 20%, 30%, 40%, 50%, 60%, 70%, 80%, 90%, 99% or 100% of the regulatory elements are part of a transcription factor pathway. In some embodiments, the invention provides a library of transcription regulatory elements in which at least 5%, 10%, 20%, 30%, 40%, 50%, 60%, 70%, 80%, 90%, 99% or 100% of the regulatory elements are part of a signaling pathway.

The present invention also provides a library of transcription regulatory elements in which the library represents at least 5%, 10%, 20%, 30%, 40%, 50%, 60%, 70%, 80%, 90%, 99% or 100% of all the regulatory elements that are part of a common pathway in the genome. In some embodiments, the invention provides a library of transcription regulatory elements in which the library represents at least 5%, 10%, 20%, 30%, 40%, 50%, 60%, 70%, 80%, 90%, 99% or 100% of all the regulatory elements that are part of an oncology pathway in the genome. In some embodiments, the invention provides a library of transcription regulatory elements in which the library represents at least 5%, 10%, 20%, 30%, 40%, 50%, 60%, 70%, 80%, 90%, 99% or 100% of all the regulatory elements that are part of a hypoxia pathway in the genome. In some embodiments, the invention provides a library of transcription regulatory elements in which the library represents at least 5%, 10%, 20%, 30%, 40%, 50%, 60%, 70%, 80%, 90%, 99% or 100% of all the regulatory elements that are part of a DNA-damage pathway in the genome. In some embodiments, the invention provides a library of transcription regulatory elements in which the library represents at least 5%, 10%, 20%, 30%, 40%, 50%, 60%, 70%, 80%, 90%, 99% or 100% of all the regulatory elements that are part of an apoptosis pathway in the genome. In some embodiments, the invention provides a library of transcription regulatory elements in which the library represents at least 5%, 10%, 20%, 30%, 40%, 50%, 60%, 70%, 80%, 90%, 99% or 100% of all the regulatory elements are part of a cell cycle pathway in the genome. In some embodiments, the invention provides a library of transcription regulatory elements in which the library represents at least 5%, 10%, 20%, 30%, 40%, 50%, 60%, 70%, 80%, 90%, 99% or 100% of all the regulatory elements that are part of a p53 pathway in the genome.

In some embodiments, the invention provides a library of transcription regulatory elements in which the library represents at least 5%, 10%, 20%, 30%, 40%, 50%, 60%, 70%, 80%, 90%, 99% or 100% of all the regulatory elements that are part of a membrane bound pathway in the genome.

In some embodiments, the invention provides a library of transcription regulatory elements in which the library represents at least 5%, 10%, 20%, 30%, 40%, 50%, 60%, 70%, 80%, 90%, 99% or 100% of all the regulatory elements are part of a nuclear receptor pathway in the genome. In some embodiments, the invention provides a library of transcription regulatory elements in which the library represents at least 5%, 10%, 20%, 30%, 40%, 50%, 60%, 70%, 80%, 90%, 99% or 100% of all the regulatory elements that are part of a glucocorticoid receptor pathway in the genome. In some embodiments, the invention provides a library of transcription regulatory elements in which the library represents at least 5%, 10%, 20%, 30%, 40%, 50%, 60%, 70%, 80%, 90%, 99% or 100% of all the regulatory elements that are part of a peroxisome proliferator-activated receptor pathway in the genome. In some embodiments, the invention provides a library of transcription regulatory elements in which the library represents at least 5%, 10%, 20%, 30%, 40%, 50%, 60%, 70%, 80%, 90%, 99% or 100% of all the regulatory elements that are part of a estrogen receptor pathway in the genome. In some embodiments, the invention provides a library of transcription regulatory elements in which the library represents at least 5%, 10%, 20%, 30%, 40%, 50%, 60%, 70%, 80%, 90%, 99% or 100% of all the regulatory elements that are part of an androgen receptor pathway in the genome. In some embodiments, the invention provides a library of transcription regulatory elements in which the library represents at least 5%, 10%, 20%, 30%, 40%, 50%, 60%, 70%, 80%, 90%, 99% or 100% of all the regulatory elements that are part of a cytochrome P450 receptor pathway in the genome. In some embodiments, the invention provides a library of transcription regulatory elements in which the library represents at least 5%, 10%, 20%, 30%, 40%, 50%, 60%, 70%, 80%, 90%, 99% or 100% of all the regulatory elements that are part of a transporter receptor pathway in the genome.

The present invention also provides a library of transcription regulatory elements in which the library represents at least 5%, 10%, 20%, 30%, 40%, 50%, 60%, 70%, 80%, 90%, 99% or 100% of all the regulatory elements that are part of a neuronal pathway in the genome. The present invention also provides a library of transcription regulatory elements in which the library represents at least 5%, 10%, 20%, 30%, 40%, 50%, 60%, 70%, 80%, 90%, 99% or 100% of all the regulatory elements that are part of a signaling pathway in the genome. The present invention also provides a library of transcription regulatory elements in which the library represents at least 5%, 10%, 20%, 30%, 40%, 50%, 60%, 70%, 80%, 90%, 99% or 100% of all the regulatory elements that are part of a vascular pathway in the genome. The present invention also provides a library of transcription regulatory elements in which the library represents at least 5%, 10%, 20%, 30%, 40%, 50%, 60%, 70%, 80%, 90%, 99% or 100% of all the regulatory elements that are part of a transcription factor pathway in the genome.

The gene expression regulatory elements include, but are not limited to, transcriptional promoters, enhancers, insulators, silencers, suppressors, and inducers. In preferred embodiments, the regulator element is a transcriptional promoter. Each of the regulatory elements can be characterized in terms of its genomic location, sequence, variation, mutation, polymorphism, transcriptional regulatory activity in different cell or tissue type, and binding affinity with other regulatory factors, such as transcription factors.

In some embodiments, the library of regulatory elements is a library of promoters. The present invention also provides a library of promoters in which at least 5%, 10%, 20%, 30%, 40%, 50%, 60%, 70%, 80%, 90%, 99% or 100% of the promoters are part of a common pathway.

In some embodiments, the invention provides a library of promoters in which at least 5%, 10%, 20%, 30%, 40%, 50%, 60%, 70%, 80%, 90%, 99% or 100% of the promoters are part of an oncology pathway. Examples of the transcriptional promoters include, but are not limited to, nucleotides selected from the group consisting of SEQ ID NO: 1-3836, or fragments thereof, such as fragments of SEQ ID NO: 1-3836 of about 100-1800, about 300-1500, about 500-1400, about 600-1300, about 700-1200, or about 800-1000 nucleotide in length, or nucleic acids having sequences with at least 70%, 75%, 80%, 85%, 90%, 95%, or 98% homology thereto. In some embodiments, the invention provides a library of promoters in which at least 5%, 10%, 20%, 30%, 40%, 50%, 60%, 70%, 80%, 90%, 99% or 100% of the promoters are part of a hypoxia pathway. In some embodiments, the invention provides a library of promoters in which at least 5%, 10%, 20%, 30%, 40%, 50%, 60%, 70%, 80%, 90%, 99% or 100% of the promoters are part of a DNA-damage pathway. In some embodiments, the invention provides a library of promoters in which at least 5%, 10%, 20%, 30%, 40%, 50%, 60%, 70%, 80%, 90%, 99% or 100% of the promoters are part of an apoptosis pathway. In some embodiments, the invention provides a library of promoters in which at least 5%, 10%, 20%, 30%, 40%, 50%, 60%, 70%, 80%, 90%, 99% or 100% of the promoters are part of a cell cycle pathway. In some embodiments, the invention provides a library of promoters in which at least 5%, 10%, 20%, 30%, 40%, 50%, 60%, 70%, 80%, 90%, 99% or 100% of the promoters are part of a p53 pathway.

In some embodiments, the invention provides a library of promoters in which at least 5%, 10%, 20%, 30%, 40%, 50%, 60%, 70%, 80%, 90%, 99% or 100% of the promoters are part of a membrane bound pathway. Examples of the transcriptional promoters include, but are not limited to, nucleotides selected from the group consisting of SEQ ID NO: 3837-12716, or fragments thereof, such as fragments of SEQ ID NO: 3837-12716 of about 100-1800, about 300-1500, about 500-1400, about 600-1300, about 700-1200, or about 800-1000 nucleotide in length, or nucleic acids having sequences with at least 70%, 75%, 80%, 85%, 90%, 95%, or 98% homology thereto.

In some embodiments, the invention provides a library of promoters in which at least 5%, 10%, 20%, 30%, 40%, 50%, 60%, 70%, 80%, 90%, 99% or 100% of the promoters are part of a nuclear receptor pathway. Examples of the transcriptional promoters include, but are not limited to, nucleotides selected from the group consisting of SEQ ID NO: 12717-13994, or fragments thereof, such as fragments of SEQ ID NO: 12717-13994 of about 100-1800, about 300-1500, about 500-1400, about 600-1300, about 700-1200, or about 800-1000 nucleotide in length, or nucleic acids having sequences with at least 70%, 75%, 80%, 85%, 90%, 95%, or 98% homology thereto. In some embodiments, the invention provides a library of promoters in which at least 5%, 10%, 20%, 30%, 40%, 50%, 60%, 70%, 80%, 90%, 99% or 100% of the promoters are part of a glucocorticoid receptor pathway. In some embodiments, the invention provides a library of promoters in which at least 5%, 10%, 20%, 30%, 40%, 50%, 60%, 70%, 80%, 90%, 99% or 100% of the promoters are part of a peroxisome proliferator-activated receptor pathway. In some embodiments, the invention provides a library of promoters in which at least 5%, 10%, 20%, 30%, 40%, 50%, 60%, 70%, 80%, 90%, 99% or 100% of the promoters are part of an estrogen receptor pathway. In some embodiments, the invention provides a library of promoters in which at least 5%, 10%, 20%, 30%, 40%, 50%, 60%, 70%, 80%, 90%, 99% or 100% of the promoters are part of an androgen receptor pathway. In some embodiments, the invention provides a library of promoters in which at least 5%, 10%, 20%, 30%, 40%, 50%, 60%, 70%, 80%, 90%, 99% or 100% of the promoters are part of a cytochrome P450 receptor pathway. In some embodiments, the invention provides a library of promoters in which at least 5%, 10%, 20%, 30%, 40%, 50%, 60%, 70%, 80%, 90%, 99% or 100% of the promoters are part of a transporter receptor pathway.

The present invention also provides a library of promoters in which the library represents at least 5%, 10%, 20%, 30%, 40%, 50%, 60%, 70%, 80%, 90%, 99% or 100% of all the promoters that are part of a common pathway in the genome.

In some embodiments, the invention provides a library of promoters in which the library represents at least 5%, 10%, 20%, 30%, 40%, 50%, 60%, 70%, 80%, 90%, 99% or 100% of all the promoters that are part of an oncology pathway in the genome. Examples of the transcriptional promoters include, but are not limited to, nucleotides selected from the group consisting of SEQ ID NO: 1-3836, or fragments thereof, such as fragments of SEQ ID NO: 1-3836 of about 100-1800, about 300-1500, about 500-1400, about 600-1300, about 700-1200, or about 800-1000 nucleotide in length, or nucleic acids having sequences with at least 70%, 75%, 80%, 85%, 90%, 95%, or 98% homology thereto. In some embodiments, the invention provides a library of promoters in which the library represents at least 5%, 10%, 20%, 30%, 40%, 50%, 60%, 70%, 80%, 90%, 99% or 100% of all the promoters that are part of a hypoxia pathway in the genome. In some embodiments, the invention provides a library of promoters in which the library represents at least 5%, 10%, 20%, 30%, 40%, 50%, 60%, 70%, 80%, 90%, 99% or 100% of all the promoters that are part of a DNA-damage pathway in the genome. In some embodiments, the invention provides a library of promoters in which the library represents at least 5%, 10%, 20%, 30%, 40%, 50%, 60%, 70%, 80%, 90%, 99% or 100% of all promoters that are part of an apoptosis pathway in the genome. In some embodiments, the invention provides a library promoters in which the library represents at least 5%, 10%, 20%, 30%, 40%, 50%, 60%, 70%, 80%, 90%, 99% or 100% of all the promoters are part of a cell cycle pathway in the genome. In some embodiments, the invention provides a library of promoters in which the library represents at least 5%, 10%, 20%, 30%, 40%, 50%, 60%, 70%, 80%, 90%, 99% or 100% of all the regulatory elements that are part of a p53 pathway in the genome.

In some embodiments, the invention provides a library of promoters in which the library represents at least 5%, 10%, 20%, 30%, 40%, 50%, 60%, 70%, 80%, 90%, 99% or 100% of all the promoters that are part of a membrane bound pathway in the genome. Examples of the transcriptional promoters include, but are not limited to, nucleotides selected from the group consisting of SEQ ID NO: 3837-12716, or fragments thereof, such as fragments of SEQ ID NO: 3837-12716 of about 100-1800, about 300-1500, about 500-1400, about 600-1300, about 700-1200, or about 800-1000 nucleotide in length, or nucleic acids having sequences with at least 70%, 75%, 80%, 85%, 90%, 95%, or 98% homology thereto.

In some embodiments, the invention provides a library of promoters in which the library represents at least 5%, 10%, 20%, 30%, 40%, 50%, 60%, 70%, 80%, 90%, 99% or 100% of all the promoters are part of a nuclear receptor pathway in the genome. Examples of the transcriptional promoters include, but are not limited to, nucleotides selected from the group consisting of SEQ ID NO: 12717-13994, or fragments thereof, such as fragments of SEQ ID NO: 12717-13994 of about 100-1800, about 300-1500, about 500-1400, about 600-1300, about 700-1200, or about 800-1000 nucleotide in length, or nucleic acids having sequences with at least 70%, 75%, 80%, 85%, 90%, 95%, or 98% homology thereto. In some embodiments, the invention provides a library of promoters in which the library represents at least 5%, 10%, 20%, 30%, 40%, 50%, 60%, 70%, 80%, 90%, 99% or 100% of all the promoters that are part of a glucocorticoid receptor pathway in the genome. In some embodiments, the invention provides a library of promoters in which the library represents at least 5%, 10%, 20%, 30%, 40%, 50%, 60%, 70%, 80%, 90%, 99% or 100% of all the promoters that are part of a peroxisome proliferator-activated receptor pathway in the genome. In some embodiments, the invention provides a library of promoters in which the library represents at least 5%, 10%, 20%, 30%, 40%, 50%, 60%, 70%, 80%, 90%, 99% or 100% of all the promoters that are part of a estrogen receptor pathway in the genome. In some embodiments, the invention provides a library of promoters elements in which the library represents at least 5%, 10%, 20%, 30%, 40%, 50%, 60%, 70%, 80%, 90%, 99% or 100% of all the promoters that are part of an androgen receptor pathway in the genome. In some embodiments, the invention provides a library of promoters in which the library represents at least 5%, 10%, 20%, 30%, 40%, 50%, 60%, 70%, 80%, 90%, 99% or 100% of all the promoters that are part of a cytochrome P450 receptor pathway in the genome. In some embodiments, the invention provides a library of promoters in which the library represents at least 5%, 10%, 20%, 30%, 40%, 50%, 60%, 70%, 80%, 90%, 99% or 100% of all the promoters that are part of a transporter receptor pathway in the genome:

Information on the structure and function of the gene expression regulatory elements relevant to biological pathways in a genome of an organism can have a wide variety of applications, including but not limited to diagnosis and treatment of diseases in a personalized manner (also known as “personalized medicine”) by association with phenotype such as onset, development of disease, disease resistance, disease susceptibility or drug response. Identification and characterization of the regulatory elements relevant to biological pathways in a genome of an organism in terms of cell- or tissue-specificity can also aid in the design of transgenic expression constructs for gene therapy with enhanced therapeutic efficacy and reduced side effects. Identification and characterization of the regulatory elements in terms of cell- or tissue-specificity can also aid in the development of function genetic markers for diagnosis, prevention and treatment of diseases. “Disease” includes but is not limited to any condition, trait or characteristic of an organism that it is desirable to change. For example, the condition may be physical, physiological or psychological and may be symptomatic or asymptomatic.

The regulatory element library may exist in an in silico form and a physical form. The in silico form is a database of sequences from the human genome representing transcriptional promoters (with size ranges as described above) and related genomic information such as the gene model and transcript it is associated with. The physical form of the regulatory element library may be a set of a plurality of individual nucleic acid fragments of the regulatory element, or plasmids each of which contains a unique promoter fragment from the human genome that is cloned upstream of a reporter gene cassette.

The physical form of the regulatory element library may be represented in several ways. One form may be as an archived library of plasmids that are frozen in small E. coli cultures. These frozen cultures can be stored indefinitely and expanded in liquid culture to produce more of the plasmids. Another form of the library may be purified plasmid DNAs that can be immediately ready for transfection. Based on the library of gene expression regulatory elements, preferably a library of transcriptional promoters, a wide variety of tools or kits can be built, such as plasmid functional macroarrays and spotted promoter microarrays, which are described below.

The regulatory element library includes a panel of plasmids, each made up of a common vector/plasmid backbone with a unique insert representing a single regulatory element from the human genome. The regulatory element fragment may be cloned immediately 5′ to a reporter gene cassette. This library can be a starting point from which two types of arrays: a plasmid functional macroarray and a spotted regulatory element microarray are built.

The plurality of different nucleic acid segments are preferably DNA segments derived from the region immediately 5′ of the transcription start site of different genes, expanding a region from about +100 to about −3000 bp, optionally about +50 to about −2000, about +20 to about −1800, about +20 to about −1500, about +10 to about −1500, about +10 to about −1200, about +20 to about −1000, about +20 to about −900, about +20 to about −800, about +20 to about −700, about +20 to about −600, about +20 to about −500, about +20 to about −400, or about +20 to about −300, relative to a transcription start site (TSS). The diversity of the plurality of different nucleic acid segments can be at least 50, optionally at least about 80, 120, 160, 200, 400, 500, 600, 800, 1000, 1500, 2000, 3000, 5000, 8000, or 10,000. Examples of transcriptional promoters include, but are not limited to, at least 2, optionally at least 5, 10, 20, 50, 100, 200, 500, 1000, 5000, 10000, or 25000 nucleotides selected from the group consisting of SEQ ID NO: 1-3836, or fragments thereof, such as fragments of SEQ ID NO: 1-3836 of about 100-1800, about 300-1500, about 500-1400, about 600-1300, about 700-1200, or about 800-1000 nucleotide in length, or nucleic acids having sequences with at least 70%, 75%, 80%, 85%, 90%, 95%, or 98% homology thereto. Examples of transcriptional promoters include, but are not limited to, at least 2, optionally at least 5, 10, 20, 50, 100, 200, 500, 1000, 5000, 10000, or 25000 nucleotides selected from the group consisting of SEQ ID NO: 3837-12716, or fragments thereof, such as fragments of SEQ ID NO: 3837-12716 of about 100-1800, about 300-1500, about 500-1400, about 600-1300, about 700-1200, or about 800-1000 nucleotide in length, or nucleic acids having sequences with at least 70%, 75%, 80%, 85%, 90%, 95%, or 98% homology thereto. Examples of transcriptional promoters include, but are not limited to, at least 2, optionally at least 5, 10, 20, 50, 100, 200, 500, 1000, 5000, 10000, or 25000 nucleotides selected from the group consisting of SEQ ID NO: 12717-13994, or fragments thereof, such as fragments of SEQ ID NO: 12717-13994 of about 100-1800, about 300-1500, about 500-1400, about 600-1300, about 700-1200, or about 800-1000 nucleotide in length, or nucleic acids having sequences with at least 70%, 75%, 80%, 85%, 90%, 95%, or 98% homology thereto.

The plurality of different DNA segments can be derived from the 5′ untranscribed region of different genes by using a computer-aided method for predicting putative transcriptional regulatory elements, such as promoters. The computer-aided method comprises: aligning a library of cDNA sequences for different genes with the genome sequence of an organism; defining the transcription start sites for each of the different genes; and selecting a segment in the genome that comprises a sequence 5′ from the transcription start site, the selected segment constituting a member of the plurality of different DNA segments.

The methods of the present invention for selecting putative gene expression regulatory elements relevant to biological pathways in a genome of an organism can be implemented in various configurations in any computing systems, including but not limited to supercomputers, personal computers, personal digital assistants (PDAs), networked computers, distributed computers on the internet or other microprocessor systems. The methods and systems described herein above are amenable to execution on various types of executable mediums other than a memory device such as a random access memory (RAM). Other types of executable mediums can be used, including but not limited to, a computer readable storage medium which can be any memory device, compact disc, zip disk or floppy disk.

FIG. 1 schematically illustrates an embodiment of the methodology disclosed herein. The flow chart in FIG. 1 illustrates a process for identifying, isolating and functionally analyzing a large number of regulatory elements, such as human transcriptional promoters that are part of a common pathway in a genome of an organism. The genes that are involved in a common pathway are identified by the methods provided in the present invention as detailed below. In one embodiment, the transcriptional promoters are identified throughout the human genome by using a computer-aided method provided in U.S. application Ser. No. 11/636,385, filed Dec. 7, 2006 entitled “Functional arrays for high throughput characterization of gene expression regulatory elements”. The promoter sequences are isolated from the genome and cloned into an expression vector containing a reporter to build a library of expression vectors containing a library of promoters which are transfected or otherwise introduced into tissue culture cells. Optionally, the promoter sequences are amplified. Transcriptional activation of the promoters results in expression of the reporter. Activity of the reporter is then assayed and serves as a quantitative indicator of the functional activity of the promoters. Oligo microarrays or “spotted” microarrays using the same promoter sequences can be used for a wide variety of other applications such as to study binding of transcription factors at all of the promoters on the array (e.g. used in conjunction with chromatin immunoprecipitation (CHIP), resulting in a CHIP-chip), and to measure the status of DNA methylation of the promoters. This methodology described herein can integrate promoter reporter activity, transcription factor binding, and epigenetic status, which should give the most complete measure of regulatory element function in a cell-based system.

### IV. LIBRARIES OF EXPRESSION CONSTRUCTS

In another embodiment, this invention provides libraries of expression constructions comprising genomic segments as described herein relevant to a biological pathway. In some embodiments, the library comprises a collection of members that are part of a common pathway, each of which contains a different nucleic acid segment from the genome. The expression constructs are recombinant nucleic acid molecules comprising a nucleic acid segment of this invention operably linked with a heterologous reporter sequence. A nucleotide sequence is operably linked with an expression control sequence when the nucleotide sequence is under the transcriptional regulatory control of the expression control sequence. The reporter sequence is heterologous to the genomic segment in that it is not naturally under the transcriptional regulatory control of the genomic segment sequence in the genome from which the nucleic acid segment comes. This recombinant nucleic acid molecule is further comprised within a vector that can be used to either infect or transiently or stably transfect cells and that may be capable of replicating inside a cell.

It should be noted that other than transcriptional promoters, libraries and arrays can be built for other types of regulatory elements following a similar principle to that for promoters. The vectors used in each case may be slightly different, however each preferably still contains a reporter cassette or construct. Different types of regulatory elements may be cloned in different positions relative to the reporter cassette.

a. Reporter Sequences

This invention contemplates a number of different reporter sequences that may be under the control of the transcriptional regulatory elements of genomic segments as described herein relevant to a biological pathway.

In one embodiment, the reporter sequence encodes a reporter protein, such as a light emitting protein (e.g., luciferase, a flouorescent protein (e.g., red, blue and green fluorescent proteins), alkaline phosphatase, secreted embryonic alkaline phosphatase (SEAP), chloramphenicol acetyl transferase (CAT), hormones and cytokines. In libraries using proteins that emit a detectable signal it may be useful, but not essential, for all of the reporter proteins to emit the same signal. This simplifies detection during high-throughput methods.

Alternatively, the expression constructs in the library may contain different reporter sequences which emit different detectable signals. For example, the reporter sequence in each of the constructs can be a unique, pre-determined nucleotide barcode. This allows assaying a large number of the nucleic acid segments in the same batch or receptacle of cells. In an embodiment, in each construct a unique promoter sequence is cloned upstream of a unique barcode reporter sequence yielding a unique promoter/barcode reporter combination. The active promoter can drive the production of a transcript containing the unique barcode sequence. Thus, in a library of expression constructs, each promoter's activity produces a unique transcript whose level can be measured. Since each reporter is unique, the library of expression constructs can be transfected into one large pool of cells (as opposed to separate wells) and all of the RNAs may be harvested as a pool. The levels of each of the barcoded transcripts can be detected using a microarray with the complementary barcode sequences. So the amount of fluorescence on each array spot corresponds to the strength of the promoter that drove the nucleotide barcode's transcription.

Optionally, the expression constructs in the library may contain a first reporter sequence and a second reporter sequence. The first reporter sequence and a second reporter sequence are preferred to be different. For example, the first reporter sequence may encode the same reporter protein (e.g., luciferase or GFP), and the second reporter sequence may be a unique nucleotide barcode. In this way, transcription can yield a hybrid transcript of a reporter protein coding region and a unique barcode sequence. Such a construct could be used either in a receptacle-by-receptacle approach for reading out the signal emitted by the reporter protein (e.g., luminescence) and/or in a pooled approach by reading out the barcodes.

By using the unique, molecular barcode for each member of the library, a large library (e.g. a library with diversity of at least 100, 150, 200, 500, 1000, 2000, or 25,000) can be assayed in a single receptacle (such as a vial or a well in a plate) rather than in thousands of individual receptacles. This approach is more efficient and economic as it can reduce costs at all levels: reagents, plasticware, and labor.

b. Vectors

The expression construct may be any vector that facilitates expression of the reporter sequence in the construct in a host cell. Any suitable vector can be used. There are many known in the art. Examples of vectors that can be used include, for example, plasmids or modified viruses. The vector is typically compatible with a given host cell into which the vector is introduced to facilitate replication of the vector and expression of the encoded reporter. Examples of specific vectors that may be useful in the practice of the present invention include, but are not limited to, E. coli bacteriophages, for example, lambda derivatives, or plasmids, for example, pBR322 derivatives or pUC plasmid derivatives; phage DNAs, e.g., the numerous derivatives of phage 1, e.g., NM989, and other phage DNA, e.g., M13 and filamentous single stranded phage DNA; yeast vectors such as the 2μ plasmid or derivatives thereof; vectors useful in eukaryotic cells, for example, vectors useful in insect cells, such as baculovirus vectors, vectors useful in mammalian cells such as retroviral vectors, adenoviral vectors, adenovirus viral vectors, adeno-associated viral vectors, SV40 viral vectors, herpes simplex viral vectors and vaccinia viral vectors; vectors derived from combinations of plasmids and phage DNAs, plasmids that have been modified to employ phage DNA or other expression control sequences; and the like.

### V. RECOMBINANT CELLS

In another aspect this invention provides recombinant cells comprising the expression libraries of this invention. Two different embodiments are contemplated in particular.

In a first embodiment each cell or group of cells comprises a different member of the expression library. Such a library of cells is particularly useful with the arrays of this invention. Typically, the library is indexed. For example, each different cell harboring a different expression vector can be maintained in a separate container that indicates the identity of the genomic segment within. The index also can indicate the particular gene or genes that is/are under the transcriptional regulatory control of the sequences naturally in the genome.

In a second embodiment, a culture of cells is transfected with a library of expression constructs so that all of the members of the library exist in at least one cell and each cell has at least one member of the expression library. The second embodiment is particularly useful with libraries in which the reporter sequences are unique sequences that can be detected independently.

As used herein the term cells and grammatical equivalents herein in meant any cell, preferably any prokaryotic or eukaryotic cell.

Suitable prokaryotic cells include, but are not limited to, bacteria such as E. coli, various Bacillus species, and the extremophile bacteria such as thermopiles, etc.

Suitable eukaryotic cells include, but are not limited to, fungi such as yeast and filamentous fingi, including species of Aspergillus, Trichoderma, and Neurospora; plant cells including those of corn, sorghum, tobacco, canola, soybean, cotton, tomato, potato, alfalfa, sunflower, etc.; and animal cells, including fish, birds and mammals. Suitable fish cells include, but are not limited to, those from species of salmon, trout, tulapia, tuna, carp, flounder, halibut, swordfish, cod and zebrafish. Suitable bird cells include, but are not limited to, those of chickens, ducks, quail, pheasants and turkeys, and other jungle foul or game birds. Suitable mammalian cells include, but are not limited to, cells from horses, cows, buffalo, deer, sheep, rabbits, rodents such as mice, rats, hamsters and guinea pigs, goats, pigs, primates, marine mammals including dolphins and whales, as well as cell lines, such as human cell lines of any tissue or stem cell type, and stem cells, including pluripotent and non-pluripotent, and non-human zygotes.

Useful cell types include primary and transformed mammalian cell lines. Suitable cells also include those cell types implicated in a wide variety of disease conditions, even while in a non-diseased state. Accordingly, suitable cell types include, but are not limited to, tumor cells of all types (e.g. melanoma, myeloid leukemia, carcinomas of the lung, breast, ovaries, colon, kidney, prostate, pancreas and testes), cardiomyocytes, dendritic cells, endothelial cells, epithelial cells, lymphocytes (T-cell and B cell), mast cells, eosinophils, vascular intimal cells, macrophages, natural killer cells, erythrocytes, hepatocytes, leukocytes including mononuclear leukocytes, stem cells such as haemopoetic, neural, skin, lung, kidney, liver and myocyte stem cells (for use in screening for differentiation and de-differentiation factors), osteoclasts, chondrocytes and other connective tissue cells, keratinocytes, melanocytes, liver cells, kidney cells, and adipocytes. In some embodiments, the cells used with the methods described herein are primary disease state cells, such as primary tumor cells. Suitable cells also include known research cell lines, including, but not limited to, Jurkat T cells, NIH3T3 cells, CHO, COS, etc. See the ATCC cell line catalog, hereby expressly incorporated by reference.

In some embodiment the cells used in the present invention are taken from an individual. In some embodiment the individual is a mammal, and in other embodiments the individual is human.

Exogenous DNA may be introduced to cells by lipofection, electroporation, or infection. Libraries in such cells may be maintained in growing cultures in appropriate growth media or as frozen cultures supplemented with Dimethyl Sulfoxide and stored in liquid Nitrogen.

### VI. FUNCTIONAL ARRAYS

In another aspect, this invention provides devices comprising a plurality of receptacles. In some embodiments, each receptacle contains a different member of expression library of this invention. In some embodiments, each receptacle contains all the members in the library. The receptacle can be any receptacle that that can holds the members of the expression library of this invention. For instance the receptacle can be a well, a vial or a tube. The receptacle can be a particle, a shallow microstructure, or a distinct location in a support. In some embodiments, the invention contemplates multiwell plates in a variety of formats and array layouts. In some embodiments, it is contemplated that a library of expression vectors can be contained within the wells of one or more 96-well, 384-well or 1536-well microtiter plates. However, it is worth noting that there are a number of standard formats well known in the art all of which can be used with the methods and compositions described herein.

In some embodiment, an array of diverse, different transcriptional regulatory elements is provided. In some embodiments, an array of different transcriptional promoters is provided. The diversity of the array is preferably at least at least 50, optionally at least 80, 120, 160, 200, 400, 500, 600, 800, 1000, 1500, 2000, 3000, 5000, 8000, 10,000, or 25,000. Also provided are a library of expression vectors each of which comprises a different gene expression regulatory element, preferably operably linked with a reporter sequence such that expression of the reporter sequence is under transcriptional control of each of the gene expression regulatory element.

For the plasmid functional array, each member of the promoter library may be transfected separately into E. coli. Each E. coli stock may be grown up to make >100 μg of each plasmid and then the plasmid DNAs are purified from the rest of the parts of the bacterial cells. In some embodiments, small aliquots of each plasmid or a mixture of plasmids (with appropriate transfection reagents) may be arrayed, e.g., in a 96-well, 384-well, or 1536-well format. This array of plasmids can be used for a number of different applications. Its primary use is preferably in the transfection of living cells. In some embodiments, a culture of cells is transfected with a library of plasmids so that all of the members of the library exist in at least one cell and/or each cell has at least one member of the expression library. In some embodiments, a culture of cells is transfected with a library of plasmids so that different members of the library exist in each cell or group of cells. Once the plasmids are delivered to living cells, the amount of activity detected from the reporter gene product reflects the transcriptional activity provided by the promoter fragment. Thus, the plasmid macroarray enables the high-throughput study of promoter function in living cells. Promoter functional assays may be conducted in a variety of cell types, in response to a change in the cellular environment, in response to an alteration in a gene sequence or function, or in the presence of a small molecule or protein sequence of interest.

In some embodiment, a highly diverse array of expression vectors is provided which comprise at least 10, 50, 100, 200, 400, 500, 600, 800, 1000, 1500, 2000, 3000, 5000, 8000, 10,000, or 25,000 different gene expression regulatory elements in the expression vectors. In some embodiment, a highly diverse array of expression vectors is provided which comprise at least 200 different gene expression regulatory elements in the expression vectors.

a. Arrays with “Naked” Nucleic Acids

In one embodiment, this invention contemplates arrays in which the receptacles contain expression vectors outside of a cellular environment. In some, arrays are contemplated in which each receptacle contains an expression vector of this invention in dried form. In some, arrays are contemplated in which each receptacle contains a library of expression vector of this invention in dried form. Such devices can be stored and shipped easily and are ready for use. In other embodiments the receptacles contain a solution comprising a nucleic acid. In other embodiments the receptacles contain a solution comprising a library of nucleic acid. In another embodiment, the solution can contain all the elements necessary for transfecting cells.

b. Arrays with Recombinant Cells

In one aspect the invention provides for arrays in which each receptacle comprises a recombinant cell or a group of recombinant cells. In some embodiments each receptacle comprises a recombinant cell or a group of recombinant cells containing an expression vector of this invention. In some embodiments each receptacle comprises a recombinant cell or a group of recombinant cells containing a library of expression vectors of this invention. These arrays are useful for carrying out high-throughput screening assays.

To generate such arrays, DNA may be mixed with serum-free media and a transfection reagent (such as a lipofection reagent), incubated, and added to a group of cells. After an incubation time, the exogenous DNA will be present in the cells. Alternate methods for delivery include electroporation and infection.

### VII. FUNCTIONAL ARRAYS

### Nucleic Acid Probe Arrays

In another aspect this invention provides DNA arrays in which the probes attached to a solid substrate comprise sequences from the nucleic acid segment libraries of this invention. Methods of making nucleic acid arrays are well known in the art. See, for example, U.S. Pat. Nos. 5,807,522 and 6,110,426 (Brown and Shalon); 6,054,270 and 6,054,270 (Southern); and 6,040,193; 5,744,305; 5,871,928; 6,610,482; 6,261,776; 6,291,183 (Affymetrix).

Methods and techniques applicable to array synthesis also have been described in U.S. Pat. Nos. 5,143,854, 5,242,974, 5,252,743, 5,324,633, 5,384,261, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, and 6,090,555. All of the above patents incorporated herein by reference in their entireties for all purposes.

The sequence of the probe can comprise the entire sequence of a genomic segment of this invention. Alternatively, a transcription regulatory sequence of this invention can be represented by one or more probes comprising a sequence of at least 21 nucleotides from a transcription regulatory sequence. The sequence can be between 21 and 35 nucleotides long, between 36 and 45 nucleotides long, between 46 and 55 nucleotides longs between 56-65 nucleotides long, or longer. In certain embodiments, a transcriptional regulatory sequence is represented by 2, 3, 4, 5, 6, 7, 8, 9 or 10 probes comprising overlapping and/or non-overlapping nucleotides sequences from the transcriptional regulatory sequence. The probes of this invention can be single stranded or double stranded.

To construct a spotted regulatory sequence microarray, small aliquots of plasmid DNA representing each member of the regulatory sequence library may be used. Because each plasmid in the library is made up of the same vector backbone with a unique regulatory element insert, primers to the vector sequence flanking the regulatory sequence insert can be designed to allow PCR amplification of the unique insert in each vector using the same set of primers for the entire library. An individual PCR reaction is then conducted for each member of the library generating a large amount of PCR product representing the unique regulatory sequence fragment. Being amplified from a plasmid template, the PCR reaction should be very robust and consistent across all regulatory sequences, which may not the case if they were amplified from genomic DNA. These purified PCR products are then used to make a spotted microarray on a glass slide either by contact print or ink-jet deposition where each feature represents a unique regulatory sequence fragment.

The arrays of this invention can be used for a number of different experimental purposes. One application is in conjunction with chromatin immunoprecipitation (ChIP). Chromatin immunoprecipitation involves cross-linking proteins to DNA in a living cell, shearing up the chromatin/DNA complex, and immunoprecipitating with an antibody to a protein of interest. The challenge is to identify the DNA sequences that are bound to the protein of interest. One option is to hybridize the ChIP DNA to a microarray to identify the targets that are enriched ChIP. Many researchers already hybridize such experimental outputs to tiled-oligo microarrays to identify binding sites across the genome. However, such experiments are prohibitively expensive for many labs. The spotted promoter microarrays or promoter-specific oligo-based microarrays provided in the present invention meet the demands of researchers conducting CHIP experiments to study promoters specifically and are looking for a less expensive alternative to tiled oligo arrays.

Another application of this spotted regulatory sequence microarray or regulatory sequence-specific oligo-based microarray is for conducting genome-wide assays of regulatory sequence DNA-methylation status, e.g. promoter DNA methylation status. In some embodiments the regulatory sequence methylation status is measured using the method for determining methylation status of regulatory elements in a high throughput manner as described above. In some embodiments the regulatory sequence methylation status is measured using a number of different techniques that exist for differentially labeling hypo-methylated and hyper-methylated DNA sequences. The results of this differential labeling at regulatory sequences can be visualized on the spotted promoter microarray or promoter-specific oligo-based microarray to determine which promoters are under or over-methylated. In some embodiments, the effect of the DNA-methylation status of one or more segments in the genome of a cell on the transcription of one or more of the regulatory sequences in the library is measured.

Another application of this spotted regulatory sequence microarray or regulatory sequence-specific oligo-based microarray is for conducting genome-wide assays of DNA polymorphism. The effect of a DNA polymorphism is a regulatory sequence on its transcription or the transcription of other regulatory elements can be measured using the methods described herein. In some embodiments, the effect of a DNA polymorphism in one or more segments in the genome of a cell on the transcription of one or more of the regulatory sequences in the library is measured.

Another application is to of this spotted regulatory sequence microarray or regulatory sequence-specific oligo-based microarray is for conducting genome-wide assays of a DNA polymorphism. The effect of a DNA polymorphism in a regulatory sequence on its transcription or the transcription of other regulatory elements can be measured using the methods described herein. In some embodiments, the effect of a DNA polymorphism in one or more segments in the genome of a cell on the transcription of one or more of the regulatory sequences in the library is measured.

Another application is to of this spotted regulatory sequence microarray or regulatory sequence-specific oligo-based microarray is for conducting genome-wide assays of a DNA mutation. The effect of a DNA mutation in a regulatory sequence on its transcription or the transcription of other regulatory elements can be measured using the methods described herein. In some embodiments, the effect of a DNA mutation in one or more segments in the genome of a cell on the transcription of one or more of the regulatory sequences in the library is measured.

Another application of this spotted regulatory sequence microarray or regulatory sequence-specific oligo-based microarray is for determining transcriptional activity of a plurality of transcriptional regulatory elements in the genome of an individual.

Yet another application of this spotted regulatory sequence microarray or regulatory sequence-specific oligo-based microarray is for determining transcriptional regulatory activity of a plurality of different nucleic acid segments under a variety of conditions and for screening the affect of a small molecule on response elements in a biological pathway.

In general, any technique that results in differential labeling of one type of sequence over another can be applied to a spotted regulatory sequence microarray or regulatory sequence-specific oligo-based microarray including DNA-hypersensitivity, histone-modifications, and more. Compared to other oligo-based regulatory sequence arrays developed by others in the field, one of the benefits for using this spotted regulatory sequence microarray or regulatory sequence-specific oligo-based microarray for such an assay is that the fragments on the array are the exact same fragments that may be tested for functional activity using the plasmid functional macroarray system.

### VIII. KITS

In an embodiment, a kit is provided for a functional macroarray of transcription regulatory sequences. The kit includes: transfection-ready set of transcription regulatory sequences plasmids, e.g., promoter plasmids. In some embodiments the set of transcription regulatory sequences plasmids are arrayed in a support, e.g., 96 or 384 wells. The kit may further include: reporter assay substrates; reagents for induction or repression of a particular biological pathway (cytokines or other purified proteins, small molecules, cDNAs, siRNAs, etc.), and/or data analysis software.

In addition, kits are provided which comprise reagents and instructions for performing methods of the present invention, or for performing tests or assays utilizing any of the compositions, libraries, arrays, or assemblies of articles of the present invention. The kits may further comprise buffers, restriction enzymes, adaptors, primers, a ligase, a polymerase, dNTPS and instructions necessary for use of the kits, optionally including troubleshooting information.

In another embodiment, a kit is provided for a CHIP assay. The kit includes: a spotted transcription regulatory sequences microarray or transcription regulatory sequences plasmids-specific oligo-based microarray; and one or more ChIP-grade antibody. The kit may further include: DNA amplification and labeling reagents; and/or data analysis software.

In yet another embodiment, a kit is provided for a DNA-methylation assay, comprising: a transcription regulatory sequences or promoter-specific oligo-based microarray; and enzyme sets for methylation assay. The kit may further include: DNA amplification and labeling reagents; and/or data analysis software.

In still another embodiment, an assembly of articles is provided for a comprehensive transcription regulatory sequences analysis, comprising: a plasmid functional macroarray kit; a promoter microarray kit for CHIP; and a DNA-methylation assay kit. The assembly may further include: analysis software for data integration.

### IX. METHODS OF USE

The functional arrays of this invention are useful, e.g., for performing high-throughput experiments to screen activity of the transcriptional regulatory sequences of this invention. This increase in throughput of functional promoter assays is important for several reasons: First, removing limits on the numbers of regulatory elements that can be assayed in a single panel allows researchers to interrogate elements corresponding to common pathways in a single experiment. For example, there are well over a thousand genes that are implicated in cancer development and progression. By scaling the promoter functional assays to include promoters of over a hundred of genes, for example over a thousand genes, researchers can study all of the promoters that are part of an oncology pathway (e.g. all cancer related genes) at once.

Furthermore, many genes have alternative promoters; therefore, increasing the throughput of these assays will allow alternative promoters to be included in a study. Particular alternative promoters have been shown to confer distinct regulation of different isoforms of the same gene, and this is an important aspect of promoter biology that needs to be included in a comprehensive study.

Increasing throughput will also enable the study of promoter sequence variants on a much larger scale. Since each promoter in the genome will likely have several SNPs on average, increasing the throughput will allow a comprehensive analysis of all existing haplotypes of a given set of promoters rather than having to pick the most common haplotypes.

Further, assaying a large number of regulatory elements in a single experiment will allow researchers to conduct statistical analyses with much greater power. The previous promoter activity experiments have shown that promoter activity data often breaks down into clusters of similar activity, just like gene clusters in microarray expression experiments. In an experiment with a small number of promoters, each sub-cluster is often too small to make any statistically significant claims as to important features unique to that cluster, such as the over-representation of certain motifs or higher-order sequence characteristics. The larger the dataset, the more power there is to perform these statistical analyses; and a diversity of promoters beyond 200 or 1,000 in a single panel would be very desirable.

A wide variety of biological samples can be tested according to the present invention, including isolated cells, cell cultures, body fluid (blood, bone marrow, saliva, spinal cord fluid, and semen), biopsy and tissue samples. The tissue samples can be any which are derived from a patient, whether human, other domestic animal, or veterinary animal. Vertebrate animals are preferred, such as humans, mice, horses, cows, dogs, and cats. The samples may be fixed or unfixed, homogenized, lysed, cryopreserved, etc. It is most desirable that matched tissue samples be used as controls. Thus, for example, a suspected colorectal cancer tissue will be compared to a normal colorectal epithelial tissue.

In one aspect of the invention, a method is provided for determining transcriptional regulatory activity of a plurality of different nucleic acid segments. The method comprises: operably linking each of the plurality of different nucleic acid segments with a reporter sequence in an expression vector such that expression of the reporter sequence is under transcriptional control of each of the different nucleic acid segments; expressing the reporter sequence; and determining the expression level of the reporter controlled by each of the different nucleic acid segments.

The present invention also provides compositions, assemblies, and kits, preferably for carrying out the methods of the present invention. For example, an array of different regulatory elements is provided, preferably an array of different transcriptional promoters. The diversity of the array is preferably at least at least 50, optionally at least 80, 120, 160, 200, 400, 500, 600, 800, 1000, 1500, 2000, 3000, 5000, 8000, 10,000, or 25,000. Also provided are a library of expression vectors each of which comprises a different gene expression regulatory element, preferably operably linked with a reporter sequence such that expression of the reporter sequence is under transcriptional control of each of the gene expression regulatory element.

b. Methods of High-Throughput Screening of Promoter Activity

i. Basic Method

An array of cells harboring the expression constructs of this invention is useful, e.g., for high-throughput screening of promoter activity. In some embodiments, a support having a member of an expression library of this invention in each receptacle of the device is filled with a cell type of interest under conditions so that the cells are transfected with the vectors. In some embodiments, a support having more than one member of an expression library of this invention in each receptacle in the support is filled with a cell type of interest under conditions so that the cells are transfected with the vectors. In some embodiments, a support having an expression library of this invention in each receptacle of the device is filled with a cell type of interest under conditions so that the cells are transfected with the vectors. The cells are then incubated under conditions chosen by the operator. Cells in which the regulatory elements are “turned on” will express the reporter sequences under their transcriptional control. The investigator then checks each receptacle of the device to measure the amount of reporter transcribed. Generally, this involves measuring the signal produced by a reporter protein encoded by the reporter sequence. For example, if the reporter protein is a fluorescent protein, then light is directed to each well and the amount of fluorescence is measured. The amount of signal measured is a function of the expression of the reporter sequence which, in turn, is a function of the activity of the transcriptional regulatory sequences.

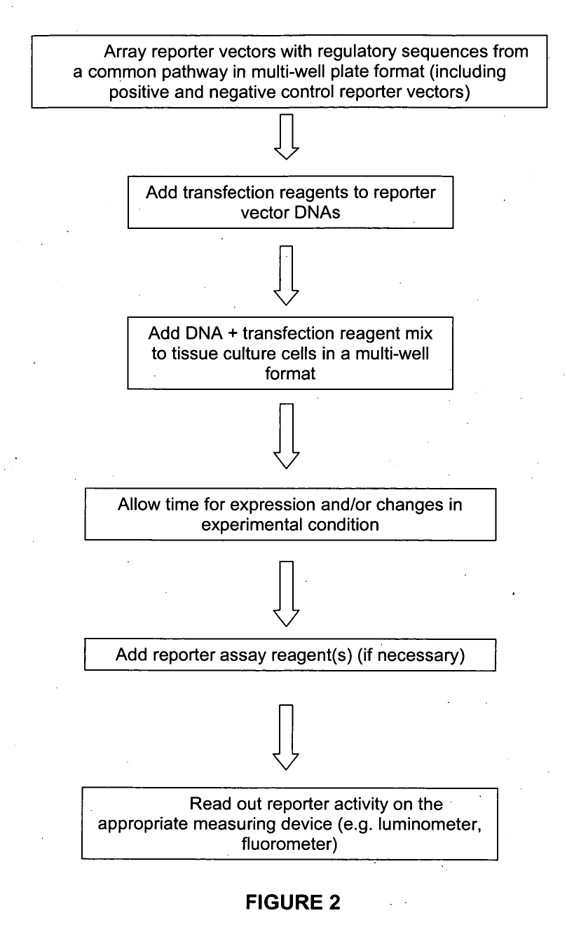

FIG. 2 schematically illustrates an embodiment of the method for detecting transcriptional activity of a plurality of regulatory elements in a common pathway in a high throughput manner. As illustrated in FIG. 2, a large number of regulatory elements contained in a library of reporter constructs are arrayed in a multi-well plate and transfected into tissue culture cells. Expression of the reporter is detected and correlated with the transcriptional activity of the regulatory elements.

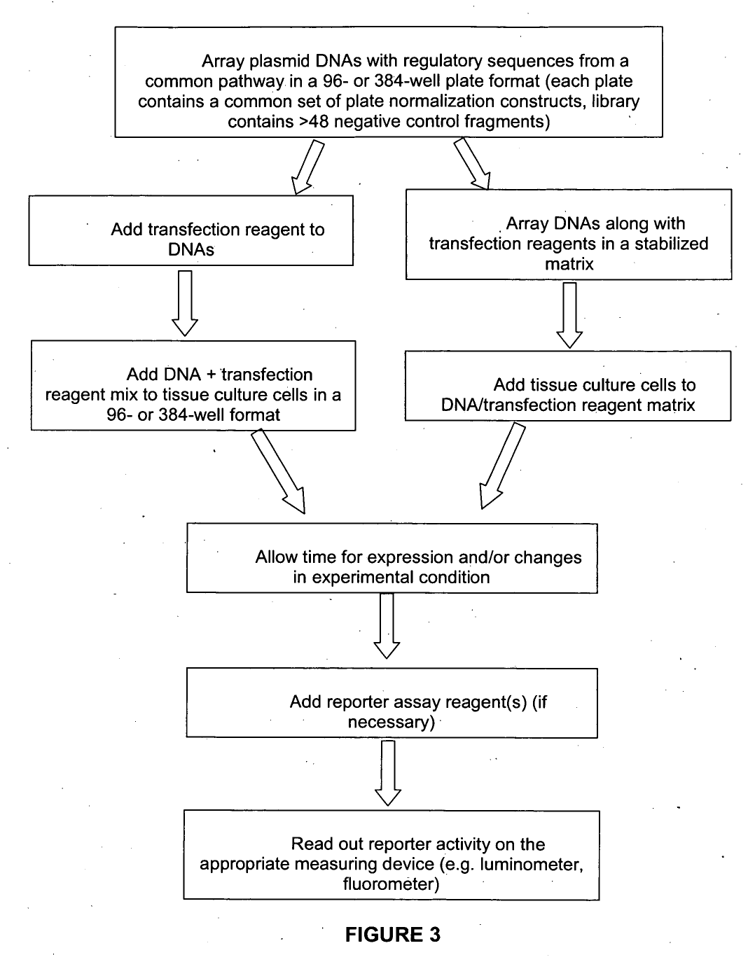

FIG. 3 schematically illustrates another embodiment of the method for detecting transcriptional activity of a plurality of regulatory elements in a common pathway in a large scale, high throughput manner. As illustrated in FIG. 3, more than a hundred regulatory elements contained in a library of reporter constructs are arrayed in a multi-well format (e.g. a 96-well or 384-plate format) and transfected into tissue culture cells. The library of reporter constructs and a transfection reagent mix can be transfected or added into tissue culture cells in a 96- or 394-well format. Alternatively and more efficiently, the library of reporter constructs and a transfection reagent mix are arrayed in a 96- or 394-well format and tissue culture cells are added into the wells later. Expression of the reporter is detected and correlated with the transcriptional activity of the regulatory elements.

By expanding from 96-well plates to 384-well plates and pre-allocating the plasmid DNAs, throughput can be expanded from hundreds to >1,000 regulatory element assays in a single experiment. Scaling this experiment to more than 1,000 independent regulatory element fragments greatly improves the scope of the research project and gives more power to the downstream statistical analyses of these data. The larger the dataset, the more amenable it is to approaches such as principle component analysis and hierarchical clustering. By studying more than 1,000 regulatory elements at once in multiple experiments, sub-clusters of promoter activity data are large enough to look for over-represented motifs or higher-order sequence characteristics.

The steps of the process are refined to increase the accuracy of regulatory element prediction and efficiency of every step, thus enabling functionally assaying multiple hundreds or thousands of regulatory elements in a single experiment and allowing thorough interrogations of common biological pathways in a single experiment: Instead of having to choose only their best candidates for assay because of a limitation on size of the experiment, by using the present invention researchers can include hundreds of genes of interest, therefore receiving much more complete and biologically relevant datasets.

Method for detecting transcriptional activity of a plurality of regulatory elements in a large scale are described in U.S. patent application Ser. No. 11/636,385, filed Dec. 7, 2006 entitled “Functional arrays for high throughput characterization of gene expression regulatory elements”.

ii. Detecting the Effect of Perturbation

In another embodiment of the methods of this invention, the investigator can test the effect of a system perturbation on the activity of a library of transcription regulatory sequences that are part of a common pathway. The basic method described above is performed under a first set of conditions to determine the amount of activity of the promoters. Then the cells are perturbed, i.e., subject to different conditions, in a manner chosen by the investigator. Perturbations can include, for example, exposing the cells to a test compound, changing environmental conditions such as temperature, pH or nutrition, or genetically modifying the cells to introduce new or modified genetic material or changes in amounts of genetic material. In some embodiment perturbations include cells that comprise one or more genetic mutation or one or more polymorphisms in their genome. After perturbation, the amount of activity of each regulatory sequence in the library is examined and compared to its activity in the first state. Regulatory sequences that show altered activity can be isolated and studied further. In this way it can be determined, for example, which transcription regulatory sequences have their activity modulated by a compound of interest.

In a variation of this method, the test is performed in parallel. That is, two identical devices of this invention are examined for regulatory sequence activity. However, one device is subjected to a first set of conditions and the other device is subjected to a second set of conditions. In this way, the relative activity of the transcription regulatory sequences under the two conditions can be examined, and sequences that have different activity can be identified and isolated.

iii. Comparison Between Cell Types

It also can be useful to identify differences in transcription regulatory sequence activity in two cell types. For example gene expression differs when cells transform from normal to cancerous. Regulatory sequences that are overactive in cancer cells may be targets of pharmacological intervention. In another example, gene expression may differ in cells having one or more polymorphisms or one or more genetic mutation in their genome. Regulatory sequences that have different expression in cells containing a polymorphism or a mutation can then help the understanding of said polymorphism or mutation in gene expression and/or may be targets of pharmacological intervention. The devices of this invention are useful to identify such transcription regulatory sequences. Accordingly, the investigator provides two sets of devices comprising expression constructs in the receptacles. One cell type is used for transformation in a first device and a second cell type, for transformation in a second device. The expression of reporter sequences between the two devices is compared to identify those expressed differently in the two cell types.

In some embodiments, the methods described herein are useful to diagnose a condition. For example, a device as described herein comprising a plurality of receptacles each receptacle containing a different member of a library of cells, wherein said cells are associated with said condition can be used to diagnose a condition. Gene expression is measured in the cells associated with the condition and an expression panel is created. The expression panel characterized the condition and hence the condition can be diagnosed. Expression panels that characterized a condition can be obtained by comparing cells associated with the condition in a diseased state with normal cells as described above.

iv. Tests in Mixed Cultures

Using expression constructs in which the transcription regulatory sequences that are part of a common pathway are operably linked to unique reporter sequences opens the possibility of performing tests without the use of a device with multiple receptacles. In such situations a single culture of cells contains the entire expression library distributed among the cells. The culture can be incubated under conditions chosen by the investigator.

In some embodiments, the expression products are isolated. As described in the section entitled “Reporter Sequences” because each one has a unique nucleotide sequence tag or barcode associated with its partner nucleic acid segment, the amount of each of the reporter sequences can be measured by measuring the amount of transcript comprising each unique sequence. For example, the molecules can be detected on a DNA array that contains probes complementary to the unique sequences. The amount of hybridization to each probe indicates the amount of the reporter sequence expressed, which, in turn, reflects the activity of the transcription regulatory sequences.

### X. PROMOTER VARIANTS

a. Identification of Promoter Variants Having Different Activity

There are many published accounts of sequence changes in promoter regions causing changes in human phenotypes or disease status. One of the classic examples is Beta-thalassemia. Just in the past few years, promoter sequence changes have also been linked to cardiovascular disease, Alzheimer disease, schizophrenia, bi-polar disorder, glaucoma, epilepsy, multiple sclerosis and lupus among others. Very recent work has also shown that a 3 base pair deletion in the promoter of the SRY gene is associated with complete sex reversal. Functional variants in the promoter of the C-reactive Protein gene have also been identified. This is particularly important because serum levels of C-reactive Protein are a key predictor of heart disease risk.

Association studies and efforts such as the Hap-Map project often detect potentially biologically interesting variation in the sequences of promoters between individuals in the human population. The big question then revolves around whether or not those sequence changes actually affect the function of the promoter or if they are essentially silent, non-functional changes. The assays provided herein can be used to compare the activity of promoter variants

This invention provides methods for identifying variants in transcriptional regulatory sequences that are associated with phenotypic differences in a population. The methods involve the following steps. First, one identifies and selects transcriptional regulatory sequences that exhibit sequence polymorphism in a population, such as SNPs, from a database of sequences or other information source. Then, one tests these variants for transcription regulation activity in an assay of this invention. Polymorphic forms that exhibit differences in activity in these assays are selected for further study. In such a study, two populations are selected that have different phenotypic traits. For example, a first population having a disease and a second population not having the disease are selected. Generally, the investigator will select a promoter that regulates expression of a gene suspected to have some connection with the phenotype in question. The population is large enough to provide statistically significant results. Each individual in the two populations are then tested to determine which form of the variant the individual has. Statistical analysis will indicate whether the polymorphic form is associated with the phenotype. Polymorphic forms found to associate with a specific phenotype then can be used in diagnostic tests to determine how likely it is that the individual has the phenotype.

More generally, the products provided in the present invention can also be used to correlate polymorphisms in a gene expression regulatory element with a phenotypic trait more efficiently. Correlation of individual polymorphisms or groups of polymorphisms with phenotypic characteristics is a valuable tool in the effort to identify DNA variation that contributes to population variation in phenotypic traits. Phenotypic traits include physical characteristics, risk for disease, and response to the environment. Polymorphisms that correlate with disease are particularly interesting because they represent mechanisms to accurately diagnose disease and targets for drug treatment. Hundreds of human diseases have already been correlated with individual polymorphisms but there are many diseases that are known to have an, as yet unidentified, genetic component and many diseases for which a component is or may be genetic.

Many diseases may correlate with multiple genetic changes making identification of the polymorphisms associated with a given disease more difficult. One approach to overcome this difficulty is to systematically explore the limited set of common gene variants for association with disease. The functional studies enabled by a regulatory element macroarray will facilitate the sorting out of sequence variants that affect the function of a regulatory element away from those that do not. Therefore, researchers may look for correlation of functional sequence variants with phenotypic traits, changing the focus from funding variants merely correlated with a phenotype towards identifying variants that may cause a particular phenotype.

To identify correlation between one or more alleles in the gene expression regulatory region and one or more phenotypic traits, individuals are tested for the presence or absence of polymorphic markers or marker sets and for the phenotypic trait or traits of interest. The presence or absence of a set of polymorphisms is compared for individuals who exhibit a particular trait and individuals who exhibit lack of the particular trait to determine if the presence or absence of a particular allele is associated with the trait of interest. For example, it might be found that the presence of allele A1 at polymorphism A in the promoter region of a gene correlates with heart disease. As an example of a correlation between a phenotypic trait and more than one polymorphism, it might be found that allele A1 at polymorphism A and allele B1 at polymorphism B correlate with a phenotypic trait of interest.

Markers or groups of markers in a gene expression regulatory region that correlate with the symptoms or occurrence of disease can be used to diagnose disease or, predisposition to disease without regard to phenotypic manifestation. To diagnose disease or predisposition to disease, individuals are tested for the presence or absence of polymorphic markers or marker sets that correlate with one or more diseases. If, for example, the presence of allele A1 at polymorphism A correlates with coronary artery disease then individuals with allele A1 at polymorphism A may be at an increased risk for the condition.

Individuals can be tested before symptoms of the disease develop. Infants, for example, can be tested for genetic diseases such as beta-thalassemia at birth. Individuals of any age could be tested to determine risk profiles for the occurrence of future disease. Often early diagnosis can lead to more effective treatment and prevention of disease through dietary, behavior or pharmaceutical interventions. Individuals can also be tested to determine carrier status for genetic disorders. Potential parents can use this information to make family planning decisions.

Individuals who develop symptoms of disease that are consistent with more than one diagnosis can be tested to make a more accurate diagnosis. If, for example, symptom S is consistent with diseases X, Y or Z but allele A1 at polymorphism A correlates with disease X but not with diseases Y or Z an individual with symptom S is tested for the presence or absence of allele A1 at polymorphism A. Presence of allele A1 at polymorphism A is consistent with a diagnosis of disease X.

b. Pharmacogenomics

In addition, the products provided in the present invention can also be used for pharmacogenomics. Pharmacogenomics refers to the study of how your genes affect your response to drugs. There is great heterogeneity in the way individuals respond to medications, in terms of both host toxicity and treatment efficacy. There are many causes of this variability, including: severity of the disease being treated; drug interactions; and the individuals age and nutritional status. Despite the importance of these clinical variables, inherited differences in the form of genetic polymorphisms can have an even greater influence on the efficacy and toxicity of medications. Genetic polymorphisms in drug-metabolizing enzymes, transporters, receptors, and other drug targets have been linked to inter-individual differences in the efficacy and toxicity of many medications. (See, Evans and Relling, Science 286: 487-491 (2001) which is herein incorporated by reference for all purposes). The functional studies enabled by a regulatory element macroarray will facilitate the sorting out of sequence variants that affect the function of a regulatory element away from those that do not. Therefore, researchers may look for correlation of functional sequence variants with phenotypic traits, changing the focus from finding variants merely correlated with a phenotype towards identifying variants that may cause a particular phenotype.

In a manner similar to that above, transcription regulatory sequences encoding genes suspected to be involved in drug metabolism are screened to identify those that exist in polymorphic forms in a population. These sequences are tested for functional differences in the assays of this invention. Those that exhibit functional differences are then examined in populations having different responses to a drug to determine whether a polymorphic form is associated with differences in drug reaction.

An individual patient has an inherited ability to metabolize, eliminate and respond to specific drugs. Correlation of polymorphisms in a gene expression regulatory region with pharmacogenomic traits identifies those polymorphisms that impact drug toxicity and treatment efficacy. This information can be used by doctors to determine what course of medicine is best for a particular patient and by pharmaceutical companies to develop new drugs that target a particular disease or particular individuals within the population, while decreasing the likelihood of adverse affects. Drugs can be targeted to groups of individuals who carry a specific allele or group of alleles. For example, individuals who carry allele A1 at polymorphism A may respond best to medication X while individuals who carry allele A2 respond best to medication Y. A trait may be the result of a single polymorphism but will often be determined by the interplay of several genes.

In addition some drugs that are highly effective for a large percentage of the population prove dangerous or even lethal for a very small percentage of the population. These drugs typically are not available to anyone. Pharmacogenomics can be used to correlate a specific genotype with an adverse drug response. If pharmaceutical companies and physicians can accurately identify those patients who would suffer adverse responses to a particular drug, the drug can be made available on a limited basis to those who would benefit from the drug.

Similarly, some medications may be highly effective for only a very small percentage of the population while proving only slightly effective or even ineffective to a large percentage of patients. Pharmacogenomics allows pharmaceutical companies to predict which patients would be the ideal candidate for a particular drug, thereby dramatically reducing failure rates and providing greater incentive to companies to continue to conduct research into those drugs.

c. Marker-Assisted Breeding

The products provided in the present invention can also be used for marker assisted breeding. Genetic markers can assist breeders in the understanding, selecting and managing of the genetic complexity of animals and plants. Agriculture industry, for example, has a great deal of incentive to try to produce crops with desirable traits (high yield, disease resistance, taste, smell, color, texture, etc.) as consumer demand increases and expectations change. However, many traits, even when the molecular mechanisms are known, are too difficult or costly to monitor during production. Readily detectable polymorphisms in a gene expression regulatory region which are in close physical proximity to the desired genes can be used as a proxy to determine whether the desired trait is present or not in a particular organism. This provides for an efficient screening tool which can accelerate the selective breeding process.

In a manner similar to that above, transcription regulatory sequences encoding genes suspected to be involved in the phenotypic trait of interest are screened to identify those that exist in polymorphic forms in a population. These sequences are tested for functional differences in the assays of this invention. Those that exhibit functional differences are then examined in populations having traits to determine whether a polymorphic form is associated with this trait.

It should be noted that the methods, libraries, arrays, kits and assemblies provided in the present invention are not limited to any particular type of nucleic acid sample: plant, bacterial, animal (including human) total genome DNA, RNA, cDNA and the like may be analyzed using some or all of the methods disclosed in this invention. The word “DNA” may be used below as an example of a nucleic acid. It is understood that this term includes all nucleic acids, such as DNA and RNA, unless a use below requires a specific type of nucleic acid.

### XI. SOFTWARE

In one aspect, the present invention provides data analysis software that identifies genes in a pathway from all of the human gene functional annotation available at the gene databases, e.g. http://www.geneontology.org and at the NCBI portal for gene annotation (http://www.ncbi.nlm.nih.gov/RefSeq/).

In another aspect, the present invention provides data analysis software that normalizes promoter strength measurements and calculates the statistical significance of each measurement with a background model. The data analysis algorithm first normalizes the data in each plate using a plurality (e.g., a set of 4, 8 or 16) of standard controls. These normalized raw values for each experimental construct are then compared to the promoter activity of a panel of at least 48, 96, or 384 random genomic fragments to assess their significance above background. These random fragments can be chosen truly randomly throughout the genome or from middle exons of protein coding genes that are at least 1000 basepairs in length and at least 5000 bases from a known transcription start site. For each experiment, the average and standard deviation of the random fragment values are calculated. A z-score is then calculated for each experimental promoter activity from the following equation: Z-score promoter activity=(raw promoter activity−mean of random controls)/standard deviation of the random controls. The confidence level for each Z-score is equal to the area under the curve assuming a Gaussian distribution of the negative control fragments after correction for multi-hypothesis testing. (i.e. fragments with a Z-score≧3 are considered active at a p<0.01 confidence level.) The Z-score transformed promoter activity data can then be compared to Z-transformed data of other types such as DNA methylation, chromatin IP combined with genomic microarrays, expression array data, etc.

### XII. METHYLATION

The present invention also provides a method for determining methylation status of CpG dinucleotides within a nucleic acid molecule, in particular, regulatory elements. In certain embodiments, the method is performed in a high throughput manner. Many regulatory elements are CpG-rich, and many CpG-rich regions represent regulatory elements. Therefore, measuring the methylation status of CpG-rich sequences provides insight into the function of many transcriptional regulatory elements.

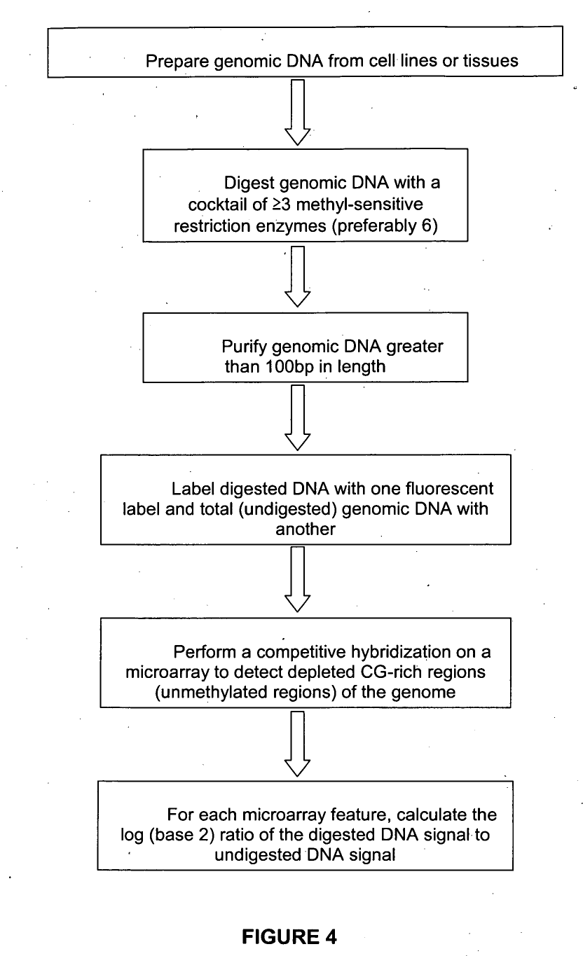

FIG. 4 schematically illustrates an embodiment of the method for large scale, high throughput determination of methylation status of CpG-rich sequence regions genome-wide. As illustrated in FIG. 4, high-molecular weight genomic DNA is prepared from cell lines or tissues and digested with at least three (preferably 6) different methyl-sensitive restriction enzymes. If the CpG-rich sequences in DNA from the source are not methylated, the methyl-sensitive enzymes will cleave these sequences into small fragments. The digested DNA greater than 100 bp in length is purified and labeled with a detectable marker such as a fluorescent label. Undigested genomic DNA is labeled with a different detectable marker. Labeling can either proceed by cleavage and end-labeling, or by hybridization of random labeled primers followed by extension of the primers. Both samples are applied in a competitive hybridization assay to a genomic microarray, such as a spotted promoter or CpG island array or an oligo array that tiles across genomic regions of interest. In DNA in which the CpG-rich areas are unmethylated, there will be a significant depletion of these CpG-rich regions, as this area will have been cleaved into small fragments less than 100 nucleotides. However, these regions will not be depleted in the un-digested DNA used as a control. Method for large scale, high throughput determination of methylation status of CpG-rich sequence regions genome-wide are described in U.S. patent application Ser. No. 11/636,385, filed Dec. 7, 2006 entitled “Functional arrays for high throughput characterization of gene expression regulatory elements”.

Individual methyl-sensitive restriction enzymes (restriction enzymes that cleave nucleic acid molecules having unmethylated recognition sequences, but not methylated recognition sequences) have been used previously to measure DNA-methylation, but they have usually been used to mark and retrieve the pieces of unmethylated DNA. The novel aspect of the approach is that it measures the depletion of these regions relative to the rest of the genome. Using a cocktail of enzymes, each with a different recognition site, enables a depletion of unmethylated regions that does not occur to the same extent under the treatment with any one enzyme alone. Examples of methylation-sensitive restriction enzymes include: AatII, AciI, AcII, AfeI, AgeI, AscI, AsiSI, AvaI, BceAI, BmgBI, BsaAI, BsaHI, BsiEI, BsiWI, BsmBI, BspDI, BspEI, BsrBI, BsrFI, BssHII, BstBI, BstUI, ClaI, EagI, FauI, FseI, FspI, HaeII, HgaI, HhaI, HinP1I, HpaII, Hpy99I, HpyCH4IV, KasI, MluI, NaeI, NarI, NgoMIV, NotI, NruI, PaeR7I, PmII, PvuI, RsrII, SacII, Sa1I, SfoI, SgrAI, SmaI, SnaBI, TilI, XhoI.

By using the method, DNA methylation status at CG-rich regions of the entire genome can be measured efficiently. The major advantage of this method is that it is very efficient, inexpensive, and measures over 97% of the “CpG islands” in the human genome with a very high specificity. DNA methylation is implicated in carcinogenesis and transcriptional regulation. Therefore, profiling the methylation status of the genome could help classify different cancers and explain mechanisms of gene regulation in specific pathways.

CpG Island and promoter arrays could be designed specifically for this assay. One embodiment of an oligonucleotide array design would be to implement an algorithm that specifically designs an array depending on the set of methyl-sensitive restriction enzymes used. This algorithm would first map a defined set of methyl-sensitive restriction enzyme recognition sites throughout a mammalian genome sequence of interest. Preferably more than 2 MSRE and approximately 6 MSRE would be used in this embodiment. A genome-wide map of the MSRE sites describes where the genomic DNA would be cut if it was not methylated at that location. After mapping a set of MSRE sites, the algorithm then calculates the distance between each neighboring MSRE site. The algorithm then clusters those MSRE sites that are less than 100 bp from each other and defines the coordinates of genomic regions bounded by at least 2 MSRE sites where the distance between neighboring MSREs within that region is less than 100 bp. These are regions of the genome that would be depleted if they were unmethylated and digested by the MSREs. Conversely, the algorithm also records those regions that would not be depleted upon digestion with the set of MSRE. These are regions that are greater than 100 bp in length that do not have MSRE recognition sequences closer than 100 bp to each other. These regions would not be depleted in the MSRE treatment and contain few, if any, CpG dinucleotides. The algorithm ultimately produces two lists of genomic regions: one that could be depleted by treatment with one or more MSRE and one that would not be depleted by treatment with one or more MSRE. Examples of depleted regions are shown in SEQ ID NOs. 45,097-45,296. Examples of recovered regions are shown in SEQ ID NOs. 45,297-45,496. The algorithm would then design oligonucleotide probes approximately 25, 30, 35, 40, 45, 50, 55, or 60 bases in length that cover 10%, 20%, 30%, 40%, 50%, 60%, 70%, 80%, 90%, or 99% of the putative “depleted regions” and another set of oligonucleotide probes approximately 25, 30, 35, 40, 45, 50, 55, or 60 bases in length that cover 10%, 20%, 30%, 40%, or 50% of the putative “recovered regions”. Hybridization and labeling of a genomic DNA sample treated with a plurality of MSRE and an untreated and labeled sample would then identify which regions were depleted, thus unmethylated in the genomic sample hybridized to the custom-designed array. The set of “recovered regions” serve as controls that are used to build an error model to measure the significance of depleted signals at putatively unmethylated regions.

Additionally, enzyme complexes that specifically cleave methylated DNA such as McrBC, could be used to perform the reciprocal experiment (identify depleted methylated regions). This approach could also be applied to whole tissues and other mammalian models.

The present invention relies on many patents, applications and other references for details known to those of the art. Therefore, when a patent, application, or other reference is cited or repeated below, it should be understood that it is incorporated by reference in its entirety for all purposes as well as for the proposition that is recited. As used in the specification and claims, the singular form “a,” “an,” and “the” include plural references unless the context clearly dictates otherwise. For example, the term “an agent” includes a plurality of agents, including mixtures thereof. An individual is not limited to a human being but may also be other organisms including but not limited to mammals, plants, bacteria, or cells derived from any of the above.

Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible subranges as well as common individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. The same holds true for ranges in increments of 105, 104, 103, 102, 10, 10-1, 10-2, 10-3, 10-4, or 10-5, for example. This applies regardless of the breadth of the range.

The practice of the present invention may employ, unless otherwise indicated, conventional techniques of organic chemistry, polymer technology, molecular biology (including recombinant techniques), cell biology, biochemistry, and immunology, which are within the skill of the art. Such conventional techniques include polymer array synthesis, hybridization, ligation, and detection of hybridization using a label. Specific illustrations of suitable techniques can be had by reference to the example herein below. However, other equivalent conventional procedures can, of course, also be used. Such conventional techniques can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), all of which are herein incorporated in their entirety by reference for all purposes.

### EXAMPLES

### Example 1

### Prediction of Putative Human Core Promoters in Genes Involve in Oncology Pathways

### Identification of Genes

The total oncology pathway set was broken down into 5 subsets: (i) Hypoxia pathway, (ii) DNA-damage pathway, (iii) Apoptosis pathway, (iv) Cell cycle pathway and (v) p53 pathway. To identify genes in each pathway, all of the human gene functional annotation available at the gene ontology database (http://www.geneontology.org/) and at the NCBI portal for gene annotation (http://www.ncbi.nlm.nih.gov/RefSeq/) was downloaded. With a genome-list of human genes and their known biological functions, custom software was written to query this compiled set of gene information for each of the 5 categories above.

Identification of genes involved in hypoxia pathways: To identify genes in the hypoxia pathway, the gene ontology annotation (described previously) for the following terms were queried: “hypoxia”, “hypoxic”, “vasculargenesis”, hypoxia inducible factor, hif. In addition, published literature databases (http://www.ncbi.nlm.nih.gov/sites/entrez?db=PubMed) were search using the terms “hypoxia” and “human” and “gene”. These genes were then included as genes previously described to be regulated by hypoxia. Furthermore, a probability matrix that describes a sequence motif known to be involved in the transcriptional regulation of the hypoxia response was used. This motif is known as the “hypoxia response element” or “HRE”. The probability matrix is shown below:

Position (5′ to 3′)

| | A | C | G | T | |
|---|---|---|---|---|---|
| 1 | 0.087 | 0.174 | 0.652 | 0.087 | G |
| 2 | 0.217 | 0.478 | 0.130 | 0.174 | N |
| 3 | 0.217 | 0.217 | 0.478 | 0.087 | N |
| 4 | 0.043 | 0.130 | 0.391 | 0.435 | K |
| 5 | 0.957 | 0.001 | 0.043 | 0.001 | A |
| 6 | 0.001 | 0.999 | 0.001 | 0.001 | C |
| 7 | 0.001 | 0.001 | 0.999 | 0.001 | G |
| 8 | 0.001 | 0.001 | 0.001 | 0.999 | T |
| 9 | 0.001 | 0.001 | 0.999 | 0.001 | G |
| 10 | 0.087 | 0.739 | 0.130 | 0.043 | C |
| 11 | 0.130 | 0.174 | 0.522 | 0.174 | G |
| 12 | 0.043 | 0.217 | 0.565 | 0.174 | G |
| 13 | 0.043 | 0.391 | 0.304 | 0.261 | N |
| 14 | 0.304 | 0.304 | 0.217 | 0.174 | N |

This probability matrix was used to evaluate each string of 14 bases in every promoter of the genome. Each promoter in the genome was ranked by this score. The top 200 promoters in the genome with the highest occurrence of the HRE were selected to be included in the hypoxia pathway panel.

Identification of genes involved in DNA-damage pathways: To identify genes in the DNA-damage pathway, the gene ontology annotation for the following terms were queried: “DNA damage”, “DNA repair”, “damaged DNA”, “damage DNA”, “nucleotide excision repair”, “double stranded break repair”, “mismatch repair”, “UV”.

Identification of genes involved in apoptosis pathways: For the apoptosis pathway, the gene ontology annotation for the following terms were queried: “apoptosis”, “onco”, “tumor suppressor”, “tumor”.

Identification of genes involved in cell cycle pathways: To identify genes in the cell cycle pathway, the gene ontology annotation for the following terms were queried: “cell cycle”.

Identification of genes involved in p53 pathways: To identify genes in the p53 pathway, the gene ontology annotation for the following terms were queried: “p53”.

Once the list of all the genes involved in the 5 oncology-related pathways described above was compiled, the extended transcriptional promoter region and sequence for each of these genes were then identified as described below. We are able to use the Refseq gene sequences that are incorporated into our promoter prediction algorithm to link the gene functional annotation to specific promoter regions in the human genome.

### Identification of Human Promoters

The extended transcriptional promoter region and sequence for each of these genes were identified using the genome-wide set of promoters that were identified in previous patent application Ser. No. 11/636,385, filed Dec. 7, 2006 entitled “Functional arrays for high throughput characterization of gene expression regulatory elements”.

### Example 2

### Prediction of Putative Human Core Promoters in Genes Involve in Membrane Pathways

The membrane pathway set includes transport proteins, G-protein coupled receptors, ion channels, cell adhesion proteins, and others.

To identify the genes of membrane pathway all of the membrane-bound proteins in the human genome were identified. To identify these genes, all of the human gene functional annotation available at the gene ontology database (http://www.geneontology.org/) and at the NCBI portal for gene annotation (http://www.ncbi.nlm.nih.gov/RefSeq/) was downloaded. With a genome-wide list of human genes and their known biological functions, custom software to query this compiled set of gene information was then written to identify all of the membrane-bound proteins in the human genome.

The software first filtered out all of the genes whose annotated component in the cell was not the membrane by eliminating genes whose component contained the terms: “cytoplasm”, “cytosol”, “cytoskeleton”, “intracellular”, “extracellular”

The software then queried the gene ontology annotation for the following terms: “GPCR”, “G protein coupled receptor”, “ion channel”, “lipid transport”, “drug transport”, “nuclear receptor”, “TNF receptor”, “nuclear pore”, “membrane”, “receptor”, “transporter”, “CXCR”, “PTHR”, “protocadherin”, “cadherin”, “T cell receptor”

Once the list of all the genes involved in membrane pathways as described above was compiled, the extended transcriptional promoter region and sequence for each of these genes were then identified using the genome-wide set of promoters that we identified in previous patent application Ser. No. 11/636,385, filed Dec. 7, 2006 entitled “Functional arrays for high throughput characterization of gene expression regulatory elements”. We are able to use the Refseq gene sequences that are incorporated into our promoter prediction algorithm to link the gene functional annotation to specific promoter regions in the human genome.

### Example 3

### Prediction of Putative Human Core Promoters in Genes Involve in Nuclear Receptor Pathways

The nuclear receptor pathway set includes the regulatory elements that control the expression of the nuclear receptor genes themselves and the regulatory elements that are bound by the nuclear receptor proteins under various conditions of hormone signaling or response to exogenous ligands. The nuclear receptor pathway set that was broken down into 6 subsets: (i) Glucocorticoid receptor pathway, (ii) Peroxisome proliferator-activated receptor pathway, (iii) Estrogen receptor pathway, (iv) Androgen receptor pathway, (iv) Cytochrome P450 pathway and (vi) Transporter pathways including ABC and SLC transporters.

To identify the regulatory elements involved in each pathway the genes involved in each of these 5 pathways were identified. To identify the genes in each pathway, all of the human gene functional annotation available at the gene ontology database (http://www.geneontology.org/) and at the NCBI portal for gene annotation (http://www.ncbi.nlm.nih.gov/RefSeq/) was downloaded. We also selected published datasets that identified genomic binding targets of nuclear receptor proteins. We also searched for the sequence motifs of the nuclear receptor proteins in our genome-wide set of human promoter sequences.

Identification of genes involved in Glucocorticoid receptor pathways: To identify the regulatory elements involved in the glucocorticoid pathway a list of 53 genes whose transcripts changed upon GR induction and whose promoters were bound by the GR protein in mouse cells were extracted from the following publication: Phuc Le P, Friedman J R, Schug J, Brestelli J E, Parker J B, et al. (2005) Glucocorticoid Receptor-Dependent Gene Regulatory Networks. PLoS Genet. 1(2): e16 doi:10.1371/journal.pgen.0010016

These regions were then mapped in the mouse genome to the synthetic regions in the human genome to identify these human GR-responsive promoters.

Two different probability matrices that describe the sequence motif known to be bound by the GR were used. This motif is known as the “glucocorticoid response element” or “GRE”. The two probability matrices are shown below:

| | Matrix1 | | | | | Matrix2 | | | | |
|---|---|---|---|---|---|---|---|---|---|---|
| | A | C | G | T | | A | C | G | T | |
| 1 | 0.211 | 0.105 | 0.474 | 0.211 | A | 0.632 | 0.001 | 0.132 | 0.237 | A |
| 2 | 0.237 | 0.211 | 0.447 | 0.105 | G | 0.026 | 0.132 | 0.790 | 0.053 | G |
| 3 | 0.237 | 0.237 | 0.184 | 0.342 | A | 0.500 | 0.158 | 0.237 | 0.105 | A |
| 4 | 0.368 | 0.237 | 0.105 | 0.290 | A | 0.868 | 0.001 | 0.026 | 0.105 | A |
| 5 | 0.132 | 0.579 | 0.158 | 0.132 | C | 0.001 | 0.999 | 0.001 | 0.001 | C |
| 6 | 0.395 | 0.211 | 0.158 | 0.237 | A | 0.999 | 0.001 | 0.001 | 0.001 | A |
| 7 | 0.316 | 0.342 | 0.105 | 0.237 | N | 0.316 | 0.342 | 0.105 | 0.237 | N |
| 8 | 0.263 | 0.079 | 0.079 | 0.579 | N | 0.263 | 0.079 | 0.079 | 0.579 | N |
| 9 | 0.211 | 0.263 | 0.395 | 0.132 | N | 0.211 | 0.263 | 0.395 | 0.132 | N |
| 10 | 0.001 | 0.001 | 0.001 | 0.999 | T | 0.001 | 0.001 | 0.001 | 0.999 | T |
| 11 | 0.001 | 0.001 | 0.999 | 0.001 | G | 0.001 | 0.001 | 0.999 | 0.001 | G |
| 12 | 0.105 | 0.026 | 0.001 | 0.868 | T | 0.105 | 0.026 | 0.001 | 0.868 | T |
| 13 | 0.105 | 0.237 | 0.158 | 0.500 | T | 0.105 | 0.237 | 0.158 | 0.500 | T |
| 14 | 0.053 | 0.790 | 0.132 | 0.026 | C | 0.053 | 0.790 | 0.132 | 0.026 | C |
| 15 | 0.237 | 0.132 | 0.001 | 0.632 | T | 0.237 | 0.132 | 0.001 | 0.632 | T |

both of these probability matrices were used to evaluate every possible stretch of 15 bases in every promoter of the genome, and then each promoter was ranked in the genome by this score. The top 200 promoters in the genome with the highest occurrence of the GRE were selected to include in our glucocorticoid receptor pathway panel.

Identification of genes involved in Peroxisome proliferator-activated receptor pathways: To identify the regulatory elements involved in the Peroxisome proliferator-activated receptor (PPAR) pathway a list of 118 genes that were previously described in the literature to be regulated by the PPAR protein was extracted. The promoter regions of these genes as described previously were then identified.

a probability matrix that describes a sequence motif known to be bound by the PPAR protein was also used. This motif is known as the “PPAR response element” or “PRE”. The probability matrix is shown below:

| | A | C | G | T | |
|---|---|---|---|---|---|
| 1 | 0.658 | 0.041 | 0.233 | 0.069 | A |
| 2 | 0.096 | 0.001 | 0.863 | 0.041 | G |
| 3 | 0.069 | 0.027 | 0.877 | 0.027 | G |
| 4 | 0.151 | 0.151 | 0.301 | 0.397 | T |
| 5 | 0.069 | 0.630 | 0.219 | 0.082 | C |
| 6 | 0.918 | 0.027 | 0.027 | 0.027 | A |
| 7 | 0.644 | 0.069 | 0.247 | 0.041 | A |
| 8 | 0.904 | 0.014 | 0.069 | 0.014 | A |
| 9 | 0.069 | 0.027 | 0.904 | 0.001 | G |
| 10 | 0.001 | 0.001 | 0.822 | 0.178 | G |
| 11 | 0.055 | 0.055 | 0.110 | 0.781 | T |
| 12 | 0.027 | 0.781 | 0.151 | 0.041 | C |
| 13 | 0.836 | 0.014 | 0.082 | 0.069 | A |

This probability matrix was used to evaluate every possible stretch of 13 bases in every promoter of the genome, and then each promoter was ranked in the genome by this score. The top 200 promoters in the genome with the highest occurrence of the PRE to include in our PPAR pathway panel were selected.

Identification of genes involved in Estrogen receptor pathways: To identify the regulatory elements involved in the estrogen receptor (ER) pathway, a list of 442 genes whose promoter regions are bound by the ER protein were extracted in the following publications: Multiplatform genome-wide identification and modeling of functional human estrogen receptor binding sites. Vinsensius B Vega* 1,2, Chin-Yo Lin* 1,3,4, Koon Siew Lai1, Say Li Kong1,3, Min Xie1,3, Xiaodi Su5, Huey Fang Teh5, Jane S Thomsen1, Ai Li Yeo1,3, Wing Kin Sung2, Guillaume Bourque2 and Edison T Liu1 http://genomebiology.com/2006/7/9/R82; Nature Genetics—38, 1289-1297 (2006); Genome-wide analysis of estrogen receptor binding sites; Jason S Carroll1, Clifford A Meyer2, 3, Jun Song2, 3, Wei Li2, 3, Timothy R Geistlinger1, Jérôme Eeckhoute1, Alexander S Brodsky4, Erika Krasnickas Keeton1, Kirsten C Fertuck1, Giles F Hall5, Qianben Wang1, Stefan Bekiranov6, 8, Victor Sementchenko6, Edward A Fox5, Pamela A Silver5, 7, Thomas R Gingeras6, X Shirley Liu2, 3 & Myles Brown1.

These 442 regions were searched for the ER binding motif (ERE) described in the probability matrix shown below:

| | A | C | G | T |
|---|---|---|---|---|
| 1 | 0.156 | 0.333 | 0.111 | 0.400 |
| 2 | 0.111 | 0.289 | 0.422 | 0.178 |
| 3 | 0.489 | 0.044 | 0.356 | 0.111 |
| 4 | 0.089 | 0.001 | 0.911 | 0.001 |
| 5 | 0.044 | 0.022 | 0.933 | 0.001 |
| 6 | 0.156 | 0.001 | 0.089 | 0.756 |
| 7 | 0.001 | 0.933 | 0.044 | 0.022 |
| 8 | 0.867 | 0.067 | 0.044 | 0.022 |
| 9 | 0.178 | 0.111 | 0.444 | 0.267 |
| 10 | 0.089 | 0.244 | 0.467 | 0.200 |
| 11 | 0.044 | 0.244 | 0.644 | 0.067 |
| 12 | 0.044 | 0.133 | 0.001 | 0.822 |
| 13 | 0.022 | 0.089 | 0.889 | 0.001 |
| 14 | 0.756 | 0.001 | 0.178 | 0.067 |
| 15 | 0.178 | 0.733 | 0.001 | 0.089 |
| 16 | 0.044 | 0.867 | 0.022 | 0.067 |
| 17 | 0.111 | 0.267 | 0.111 | 0.511 |
| 18 | 0.222 | 0.111 | 0.311 | 0.356 |
| 19 | 0.022 | 0.244 | 0.667 | 0.067 |

The total list of 442 was narrowed down to a list of 384 based on the promoter sequences with the highest occurrence of the ERE.

Identification of genes involved in Androgen receptor pathways: To identify the regulatory elements involved in the androgen receptor (AR) pathway, a list of 129 genes that were previously described in the literature to be regulated by the AR protein was extracted the promoter regions of these genes were then identified as described previously.

Identification of genes involved in Cytochrome P450 pathways: To identify the regulatory elements of cytochrome P450 proteins we first needed to identify all of these genes in the human genome. To identify these genes, all of the human gene functional annotation available at the gene ontology database (http://www.geneontology.org/) and at the NCBI portal for gene annotation (http://www.ncbi.nlm.nih.gov/RefSeq/) were downloaded. With a genome-wide list of human genes and their known biological functions, a custom software was then wrote to query this compiled set of gene information to identify all of the membrane-bound proteins in the human genome.

The software then queried the gene description and ontology annotation for the following terms: “P450”, “cytochrome P450”

This search resulted in a list of 66 cytochrome P450 genes in the human genome. The extended transcriptional promoter region and sequence for each of these genes were then identified using the genome-wide set of promoters identified in previous patent application Ser. No. 11/636,385, filed Dec. 7, 2006 entitled “Functional arrays for high throughput characterization of gene expression regulatory elements”.

Identification of genes involved in transporter pathways including ABC and SLC transporters: To identify the regulatory elements of ABC and SLC transporters proteins all of these genes in the human genome were first identified. To identify these genes, all of the human gene functional annotation available at the gene ontology database (http://www.geneontology.org/) and at the NCBI portal for gene annotation (http://www.ncbi.nlm.nih.gov/RefSeq/) we downloaded. With a genome-wide list of human genes and their known biological functions, a custom software was then written to query this compiled set of gene information to identify all of the membrane-bound proteins in the human genome.

The software then queried the gene description and ontology annotation for the following terms: “ATP-binding cassette, sub-family,” “solute carrier family AND (fatty) OR (lipid) OR (sugar) OR (glucose)”

This search resulted in a list of 88 ABC and SLC transporter genes in the human genome. The extended transcriptional promoter region and sequence for each of these genes were identified using the genome-wide set of promoters identified in U.S. patent application Ser. No. 11/636,385, filed Dec. 7, 2006 entitled “Functional arrays for high throughput characterization of gene expression regulatory elements”.

To complete the nuclear receptor pathway panel, all of the promoters for the nuclear receptor genes themselves were also identified. Using similar searches as those described above, a list of 49 nuclear receptor genes in the human genome were identified. We then identified the extended transcriptional promoter region and sequence for each of these genes using the genome-wide set of promoters identified in previous patent application Ser. No. 11/636,385, filed Dec. 7, 2006 entitled “Functional arrays for high throughput characterization of gene expression regulatory elements”.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A library of a plurality of different expression constructs, each member of the library comprising a different nucleic acid segment from a genome, wherein the segment comprises transcription regulatory sequences operably linked with a heterologous reporter sequence in an expression vector such that expression of the reporter sequence is under transcriptional control of the transcription regulatory sequences, wherein a plurality comprising at least 20% of the transcription regulatory sequences of said expression constructs in said library are part of a common pathway.

2. The library of claim 1 wherein the transcription regulatory sequences that are part of a common pathway control the expression of genes involved in the same biological process.

3. The library of claim 1 wherein the transcription regulatory sequences that are part of a common pathway are all bound by the same transcription factor protein, complex of transcription factor proteins, other nucleic acid binding proteins, or other small molecule.

4. The library of claim 1 wherein the transcription regulatory sequences that are part of a common pathway control the expression of genes whose transcript levels or proteins levels change upon treatment or exposure to the same stimulus.

5. The library of claim 1 wherein the transcription regulatory sequences that are part of a common pathway contain the same DNA sequence motif or collection of DNA sequence motifs wherein a sequence motif is string of 2 or more nucleotides.

6. The library of claim 1 wherein the transcription regulatory sequences that are part of a common pathway control the expression of genes whose sequences, transcripts or proteins are connected via metabolic transformations and/or physical protein-protein, protein-DNA and protein-compound interactions.

7. The library of claim 1 wherein said common pathway is selected from the group consisting of oncology, membrane, vascular, neuronal, signaling and nuclear receptor pathway.

8. The library of claim 7 wherein said common pathway is an oncology pathway.

9. The library of claim 8 wherein said oncology pathway is selected from the group consisting of hypoxia pathway, DNA-damage pathway, apoptosis-pathway, cell cycle pathway, and p53 pathway,

10. The library of claim 9 wherein the regulatory elements are selected from the group consisting of SEQ ID NO: 1-3836.

11. The library of claim 8 comprising a plurality of transcription regulatory sequences differently selected from the group consisting of hypoxia pathway, DNA-damage pathway, apoptosis pathway, cell cycle pathway, and p53 pathway.

12. The library of claim 11 wherein the regulatory elements are selected from the group consisting of SEQ ID NO: 1-3836.

13. The library of claim 7 wherein said common pathway is a membrane pathway.

14. The library of claim 13 wherein said membrane pathway is selected from the group consisting of transport protein pathways, G-protein coupled receptor pathways, ion channel pathways, and cell adhesion protein pathways.

15. The library of claim 14 wherein the regulatory elements are selected from the group consisting of SEQ ID NO: 3837-12716.

16. The library of claim 13 comprising a plurality of transcription regulatory sequences differently selected from the group consisting of transport protein pathways, G-protein coupled receptor pathways, ion channel pathways, and cell adhesion protein pathways.

17. The library of claim 16 wherein the regulatory elements are selected from the group consisting of SEQ ID NO: 3837-12716.

18. The library of claim 7 wherein said common pathway is a nuclear receptor pathway.

19. The library of claim 7 wherein said nuclear receptor pathway is selected from the group consisting of glucocorticoid receptor pathway, peroxisome proliferator-activated receptor pathway, estrogen receptor pathway, androgen receptor pathway, cytochrome P450 pathway, and transporter pathways.

20. The library of claim 19 wherein the regulatory elements are selected from the group consisting of SEQ ID NO: 12717-13994.

21. The library of claim 18 comprising a plurality of transcription regulatory sequences differently selected from the group consisting of glucocorticoid receptor pathway, peroxisome proliferator-activated receptor pathway, estrogen receptor pathway, androgen receptor pathway, cytochrome P450 pathway, and transporter pathways.

22. The library of claim 21 wherein the regulatory elements are selected from the group consisting of SEQ ID NO: 12717-13994.

23. The library of claim 1 wherein said library comprises at least ten, at least 50, at least 100, at least 200, or at least 1000 expression constructs.

24. The library of claim 1 wherein the segments have an average length of at least 200 nucleotides.

25. The library of claim 1, wherein the average length of the nucleic acid segments in the library is between 200 nucleotides and 3000 nucleotides.

26. The library of claim 1, wherein each nucleic acid segment comprises at least 200 nucleotides upstream of a transcriptional start site.

27. The library of claim 1, wherein the reporter sequences encode the same reporter molecule.

28. The library of claim 1, wherein the reporter sequence encodes a light-emitting reporter molecule, a fluorescent reporter molecule or a colorimetric molecule.

29. The library of claim 1, wherein each reporter sequence comprises a pre-determined, unique nucleotide barcode and/or a reporter that reports a visible signal.

30. The library of claim 1, wherein the genome is a mammalian genome.

31. The library of claim 1, wherein the genome is a human genome.

32. The library of claim 1, wherein the genome is a mouse genome.

33. The library of claim 1 comprising at least 10 different expression constructs, wherein about 50% of the transcription regulatory sequences of said expression constructs in said library are part of said common pathway.

34. A library of isolated nucleic acid molecules, each member of the library comprising a different, pre-determined nucleic acid segment from a genome, wherein the segment comprises transcription regulatory sequences, wherein a plurality comprising at least 20% of the transcription regulatory sequences in said library are part of a common pathway.

35. The library of claim 34 comprising at least 10 different pre-determined nucleic acid segment from a genome, wherein about 50% of the transcription regulatory sequences of said library are part of said common pathway.

36. A library of cells, wherein each cell in the library of cells comprises a different member of a library of expression constructs, wherein each member of the library of expression constructs comprises a different nucleic acid segment from a genome, wherein the segment comprises transcription regulatory sequences, operably linked with a heterologous reporter sequence in an expression vector such that expression of the reporter sequence is under transcriptional control of the transcription regulatory sequences, wherein a plurality comprising at least 20% of the transcription regulatory sequences of said expression constructs in said library are part of a common pathway.

37. The library of claim 36 wherein the cells are human cells.

38. The library of claim 36 wherein the cells are non-human cells.

39. The library of claim 36 comprising at least at least 10 different expression constructs wherein about 50% of the transcription regulatory sequences of said expression constructs in said library are part of said common pathway.

40. A device comprising a plurality of receptacles, each receptacle containing a different member of a library of expression constructs, each expression construct comprising a different, nucleic acid segment from a genome, wherein the segment comprises transcription regulatory sequences, operably linked with a heterologous reporter sequence in an expression vector such that expression of the reporter sequence is under transcriptional control of the transcription regulatory sequences, wherein a plurality comprising at least 20% of the transcription regulatory sequences of said expression constructs in said library are part of a common pathway and wherein each member has a known location among the receptacles.

41. The device of claim 40, wherein the library has a diversity of at least 10 different nucleic acid segments.

42. The device of claim 40 wherein the average length of the nucleic acid segments in the library is at least 200 nucleotides.

43. The device of claim 40, wherein the constructs are in the form of a dried nucleic acid or are in solution.

44. The device of claim 42 wherein the constructs are in a stabilized transfection matrix.

45. The device of claim 42 comprising a microtiter plate such as a 96-well plate, a 384-well plate or a 1536 well plate.

46. The device of claim 40 comprising at least at least 10 different expression constructs wherein about 50% of the transcription regulatory sequences of said expression constructs in said library are part of said common pathway.

47. A device comprising a solid substrate comprising a surface and nucleic acid molecules immobilized to the surface, each at a different known location, wherein each molecule comprises a nucleotide sequence of at least 10 nucleotides from a genomic segment comprising transcription regulatory sequences and wherein a plurality comprising at least 20% of the transcription regulatory sequences in said device are part of a common pathway.

48. The device of claim 47 wherein said device comprises transcription regulatory sequences from at least 10 different genomic segments.

49. The device of claim 47 comprising at least 10 different transcription regulatory sequences from genomic segments wherein about 50% of the transcription regulatory sequences in said device are part of a common pathway.

50. The device of claim 47 wherein each genomic segment is represented by a set comprising a plurality of molecules, each molecule in the set comprising a different nucleotide sequence from the genomic segment.

51. A method comprising:
(a) providing a device comprising a plurality of receptacles, each receptacle containing a different member of a library of cells, wherein each cell in the library of cells comprises a different member of the library of expression constructs, each expression construct comprising a different nucleic acid segment from a genome, wherein the segment comprises transcription regulatory sequences, operably linked with a heterologous reporter sequence in an expression vector such that expression of the reporter sequence is under transcriptional control of the transcription regulatory sequences; wherein a plurality comprising at least 20% of the transcription regulatory sequences in said device are part of a common pathway and wherein each member of the library of cells has a known location among the receptacles;
(b) culturing the cells; and
(c) measuring the level of expression of the reporter sequence in each receptacle.

52. The method of claim 51 wherein the library has a diversity of at least 10 different nucleic acid segments.

53. The method of claim 51 wherein the average length of the nucleic acid segments in the library is at least 200 nucleotides.

54. The method of claim 51 wherein the step of providing the device comprises:
(i) providing a device comprising at least one plate comprising a plurality of receptacles, each receptacle containing a different member of the library of expression constructs, wherein each member of the library of expression constructs has a known location among the receptacles;
(ii) delivering cells to each of the receptacles; and
(iii) transfecting the cells with the expression constructs.

55. The method of claim 51 further comprising:
(d) perturbing the cells in each receptacle;
(e) measuring the level of expression of the reporter sequence in each receptacle; and
(f) determining whether the level of expression in any receptacle changed after perturbing the cells.

56. The method of claim 55 wherein perturbing comprises contacting the cells in each receptacle with a test compound, exposing the cells to different environmental conditions, or genetically modifying the cells either permanently or transiently such as by inducing mutation, overexpressing a transcript for example by transfecting with a cDNA or decreasing expression of a transcript by siRNA.

57. The method of claim 56 wherein perturbing comprises contacting the cells in each receptacle with a test compound.

58. The method of claim 57 further comprising identifying a compound that alters transcription of one or more polynucleotides.

59. The method of claim 51 wherein said cells in said library of cells comprises cells associated with a condition.

60. The method of claim 51 wherein each cell in said library of cells comprises a DNA polymorphism such as SNP, STR, VTR and RFLP, DNA mutation or DNA epigenetic change.

61. The method of claim 60 wherein said DNA epigenetic change is selected for the group consisting of chemical modifications and chromatin structure.

62. The method of claim 61 wherein said DNA epigenetic change is a chemical modification.

63. The method of claim 62 wherein said chemical modification is DNA methylation.

64. A method to determine the functional effect of a DNA polymorphism, DNA mutation or DNA epigenetic change in the transcriptional activity of a polynucleotide comprising:
(a) providing a first library of cells wherein said first library comprises cells comprising said DNA polymorphism, DNA mutation or DNA epigenetic change;
(b) providing a second library of cells wherein said second library comprises cells not comprising said DNA polymorphism, DNA mutation or DNA epigenetic change;
(c) providing a device comprising a plurality of receptacles, each receptacle containing a different member of said first library of cells or said second library of cells, wherein each cell in said first and second library of cells comprises a different member of the library of expression constructs, each expression construct comprising a different nucleic acid segment from a genome, wherein the segment comprises transcription regulatory sequences, operably linked with a heterologous reporter sequence in an expression vector such that expression of the reporter sequence is under transcriptional control of the transcription regulatory sequences; wherein a plurality comprising at least 20% of the transcription regulatory sequences in said device are part of a common pathway and wherein each member of the library of cells has a known location among the receptacles;
(d) culturing the cells;
(e) measuring the level of expression of the reporter sequence in each receptacle;
(f) comparing the level of expression of the reporter sequence to each transcription regulatory sequence between said first library of cells and said second library of cells thereby determining the effect of said DNA polymorphism, DNA mutation or DNA epigenetic change in the transcriptions of a polynucleotide.

65. The method of claim 64 wherein said DNA polymorphism is selected for the group consisting of SNP, STR, VTR, RFLP, deletions, and insertions.

66. The method of claim 64 wherein said DNA epigenetic change is selected for the group consisting of chemical modifications and chromatin structure.

67. The method of claim 66 wherein said DNA epigenetic change is a chemical modification.

68. The method of claim 67 wherein said chemical modification is DNA methylation.

69. A business method comprising commercializing the compositions, devices of methods of claim 1, 34, 36, 40, 47, 51 and 64.
